(19) United States
(12) Patent Application Publication
(10) Pub. No.: US 2025/0201143 A1
(43) Pub. Date: Jun. 19, 2025

(54) SYSTEMS AND METHODS FOR CREATING AND UPDATING COURSE MATERIAL

(71) Applicant: Finance|able, Philadelphia, PA (US)

(72) Inventor: Michael Kimpel, Philadelphia, PA (US)

(21) Appl. No.: 18/987,736

(22) Filed: Dec. 19, 2024

Related U.S. Application Data
(60) Provisional application No. 63/612,087, filed on Dec. 19, 2023.

(51) Int. Cl. G09B 7/08; G06Q 50/20

(52) U.S. Cl. CPC G09B 7/08; G06Q 50/20

(57) ABSTRACT

Systems and methods for automatically creating and updating course materials are disclosed. A learning management (LM) system in accordance with the present disclosure comprises at least one memory and a processor in communication with the at least one memory. The processor is programmed to receive, from a teacher or other user, topic data corresponding to one or more lessons. The processor may be further configured to apply the topic data to one or more trained machine learning models to generate a topic summary corresponding to the one or more lessons; cause to be displayed, on a user computing device, the topic summary corresponding to the one or more lessons via a topic summary user interface; receive feedback on the one or more lessons via the topic summary user interface; and update a course syllabus based on the feedback on the one or more lessons.

### CROSS-REFERENCE TO RELATED APPLICATIONS

This application claims the benefit of U.S. Provisional Application No. 63/612,087, filed Dec. 19, 2023, which is hereby incorporated by reference as though fully set forth herein.

### FIELD OF THE INVENTION

The present invention relates generally to learning management and, more specifically, to systems and methods for automatically generating and updating course material.

### BACKGROUND

Traditionally, teachers manually create their own syllabi and course materials. In addition, syllabi usually remain static throughout the duration of a course, regardless of student comprehension and/or feedback of the material. Further, there is generally no mechanism by which a teacher may automatically gather data regarding student feedback and/or comprehension of the material being taught. Therefore, systems and methods for automatically generating and updating syllabuses and other course material according to student comprehension and/or student feedback of the material in real-time as the course progresses, is desirable.

### BRIEF SUMMARY OF THE INVENTION

One aspect of the present disclosure includes a learning path (LP) system comprising at least one memory and at least one processor in communication with the at least one memory. The at least one processor is programmed to: receive, from a user, topic data corresponding to one or more lessons; apply the topic data to one or more trained machine learning models to generate a topic summary corresponding to the one or more lessons; cause to be displayed, on a user computing device, the topic summary corresponding to the one or more lessons via a topic summary user interface; receive feedback on the one or more lessons via the topic summary user interface; and update a course syllabus based on the feedback on the one or more lessons.

Another aspect of the present disclosure includes a computer-implemented LP method implemented using a system including a computing device including a processor communicatively coupled to a memory device, the method comprising: receiving, from a user, topic data corresponding to one or more lessons; apply the topic data to one or more trained machine learning models to generate a topic summary corresponding to the one or more lessons; causing to be displayed, on a user computing device, the topic summary corresponding to the one or more lessons via a topic summary user interface; receiving feedback on the one or more lessons via the topic summary user interface; and updating a course syllabus based on the feedback on the one or more lessons.

Yet another aspect of the present disclosure includes a non-transitory computer-readable storage medium having computer-executable instructions stored thereon, when executed by a processor of a computing device of a LM system, the computer-executable instructions cause the processor to: receive, from a user, topic data corresponding to one or more lessons; apply the topic data to one or more trained machine learning models to generate a topic summary corresponding to the one or more lessons; cause to be displayed, on a user computing device, the topic summary corresponding to the one or more lessons via a topic summary user interface; receive feedback on the one or more lessons via the topic summary user interface; and update a course syllabus based on the feedback on the one or more lessons.

### BRIEF DESCRIPTION OF THE DRAWINGS

There are shown in the drawings arrangements which are presently discussed, it being understood, however, that the present embodiments are not limited to the precise arrangements and are instrumentalities shown, wherein:

FIG. 1 illustrates a simplified functional block diagram of a Learning Path (LP) computing system in accordance with an exemplary embodiment of the present disclosure.

FIG. 2 illustrates an exemplary client computing device that may be used with the exemplary LP computing system illustrated in FIG. 1.

FIG. 3 illustrates an exemplary server computing device that may be used with the exemplary LP computing system illustrated in FIG. 1.

FIG. 4 is a first tree diagram for a topic area in accordance with an embodiment of the present disclosure.

FIG. 5 is a second tree diagram for a topic area in accordance with an embodiment of the present disclosure.

FIG. 6 is a third tree diagram for a topic area in accordance with an embodiment of the present disclosure.

FIG. 7 is a knowledge course user interface in accordance with an embodiment of the present disclosure.

FIG. 8 is a flow diagram of global diagnostics in accordance with an embodiment of the present disclosure.

FIG. 9 is a tree diagram illustrating dynamic diagnostics and calculation flows in accordance with an embodiment of the present disclosure.

FIG. 10 is an example user interface for viewing user completion statistics in accordance with an embodiment of the present disclosure.

FIG. 11 is a schematic diagram illustrating a prediction model in accordance with an embodiment of the present disclosure.

FIG. 12A is a question creation user interface in accordance with an embodiment of the present disclosure.

FIG. 12B is a lesson creation user interface in accordance with an embodiment of the present disclosure.

FIG. 13 is a tutor user interface in accordance with an embodiment of the present disclosure.

FIG. 14 is a basic multi-layer heat map user interface in accordance with an embodiment of the present disclosure.

FIG. 15 is a comprehensive example heat map user interface in accordance with an embodiment of the present disclosure.

FIG. 16 is a multi-dimensional heat map user interface in accordance with an embodiment of the present disclosure.

FIG. 17 is a method for generating and presenting a customized learning path in accordance with an embodiment of the disclosure.

FIG. 18 is a schematic diagram of a learning management (LM) system in accordance with an embodiment of the present disclosure.

FIG. 19 is a topic summary user interface in accordance with an embodiment of the present disclosure.

FIG. 20 is a topic summary user interface in accordance with an embodiment of the present disclosure.

FIG. 21 is diagram of emotional readout data in accordance with an embodiment of the present disclosure.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, systems and methods for providing a non-linear and personalized learning path enhanced by artificial intelligence and machine learning elements. In one exemplary embodiment, the process may be performed by one or more computing devices, such as a Learning Path (LP) computing device. The goal is to help learners loop through a more growth mindset approach by pinpointing weaknesses and provide ways to improve upon those weaknesses. To maximize learning and retention, the system breaks topic areas of study into a hierarchical taxonomy so a learner can navigate areas of study they need to master but doing it in an intuitive way. In some embodiments, this may be done using a tag-based approach. The system uses a non-linear personalized approach to learning that meets the learner where they are and help them see the path ahead. For example, the system provides the learner with a path because the learner doesn't know what they don't know. The system loops learners in, meets them where they are, and provides a guided path to where they want to be.

In some embodiments, data is gathered and subsequently shared with, for example, potential employers to help bridge the gap. For example, the LP system may provide candidate suggestions the potential employers may have otherwise not known about and may provide clarity to potential employers about a user's knowledge, skills, and strengths.

In some embodiments described herein, LP system may include finance training, however LP system may be applicable to any area of learning. For example, in a high-level flow, an individual, or user, may set their path. The LP system may first figure out where the user is on their learning path and saved as an understanding of where they are. Next, the LP system may provide the user with one or more courses to learn. Based on their performance, which is determined using diagnostics, the understanding of the user may be updated. Other options may include live tutoring (e.g., a person, chat bot, avatar, etc.), meeting with certain people (e.g., other students, counselors, etc.). The LP system continuously seeks out best options available to the user to help them ultimately achieve goal completion.

In some embodiments, the LP system may be provided to a user via a web browser, for example. The web browser may be goal-specific, or provided on a higher-level (e.g., finance training). Using the website, the user provides, as inputs, an idea of where they are now in their journey and where they want to be. One or more algorithms may generate a path for the user to achieve their goal. A path matrix may comprise a multi-dimensional path that is personalized for the user. Each intersection of the matrix lists, for example, initial courses and timelines for users to take. For example, a liberal arts major student wanting to go into private equity would be provided with very different learning path than a finance major student wanting to go into private equity. For example, different course listings may be provided along with recommended timelines. Customizable features may be provided, such as the ability to toggle timelines as well as tightening and expanding timelines. Additionally, courses may be broken down into repeatable 15-30-minute chunks, for example. Different time values include, but are not limited to, course length, current date, target date, work schedule, school schedule, weekend availability, or the like. Additionally, different users may be provided with different learning paths based on machine learning techniques. The machine learning accounts for different students being able to grasp particular topics at different rates. Some students may need little help, or no help at all, the diagnostic rates their competency, and their learning path is updated accordingly. Another student may require additional help and time, causing the diagnostic to adjust the student's learning path accordingly. Through machine learning, the LP system figures out the typical time and the typical path in particular based on answers students are giving to questions.

The LP system described herein may provide the following technical advantages: (i) tailoring underlying content across a multi-dimensional matrix of skills, knowledge, capabilities, and/or other dimensions; (ii) developing root level capabilities, and (iii) measuring skills, knowledge, capabilities, and/or other dimensions as well as simultaneously helping learners improve upon their skills, knowledge, capabilities, and/or other dimensions.

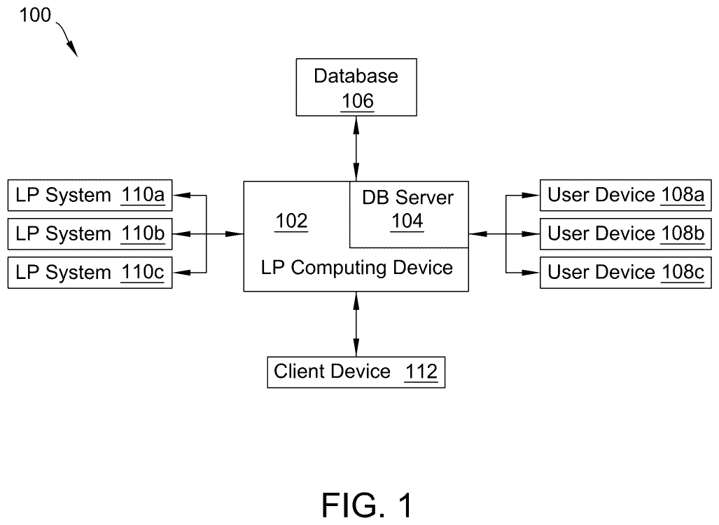

FIG. 1 depicts a simplified block diagram of an exemplary Learning Path (LP) computing system 100. In the exemplary embodiment, system 100 may be used for providing a non-linear and personalized learning path. In the exemplary embodiment, system 100 may include a Learning Path (LP) computing device 102 and a database server 104. LP computing device 102 may be in communication with one or more databases 106 (or other memory devices), user computing devices 108a-108c, client device 112, and/or LP network systems 110a-110c.

In the exemplary embodiment, user computing devices 108a-108c and client device 112 may be computers that include a web browser or a software application, which enables user computing devices 108a-108c or client device 112 to access remote computer devices, such as LP computing device 102, using the Internet or other network. In some embodiments, the LP computing device 102 may receive one or more goals, learning plans, historical data inputs, or the like, from devices 108a-108c or 112, for the LP systems 110a-110c, for example. It is understood that more, or less, than the user devices and LP systems shown in FIG. 1. The number of devices shown is meant to be for illustrative purposes only. In the exemplary embodiment, LP systems 110a-110c may be systems, or networks, which implement machine learning processes.

In some embodiments, user computing devices 108a-108c may be communicatively coupled to LP computing device 102 through many interfaces including, but not limited to, at least one of the Internet, a network, such as the Internet, a local area network (LAN), a wide area network (WAN), or an integrated services digital network (ISDN), a dial-up-connection, a digital subscriber line (DSL), a cellular phone connection, and a cable modem. User computing devices 108a-108c may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, user computing devices 108a-108c may transmit data to LP computing device 102 (e.g., user data including a user identifier, applications associated with a user, etc.). In further embodiments, user computing devices 108a-108c may be associated with users associated with certain datasets. For example, users may provide machine learning datasets comprised of historical data, or the like.

A series of LP systems 110a-110c may be communicatively coupled with LP computing device 102. In some embodiments, LP systems 110a-110c may be designed and/or optimized based on machine learning techniques described herein. In some embodiments, LP systems 110a-110c may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

In some embodiments, database 106 may store learning models that may be used to design and/or optimize an LP network. For example, database 106 may store a series of learning models intended to be utilized for training neural networks.

Database server 104 may be communicatively coupled to database 106 that stores data. In one embodiment, database 106 may include application data, rules, application rule conformance data, etc. In the exemplary embodiment, database 106 may be stored remotely from LP computing device 102. In some embodiments, database 106 may be a decentralized database, a distributed ledger, or the like. In the exemplary embodiment, a user, via a client device 112 or one of user devices 108a-108c, may access database 106 and/or LP computing device 102.

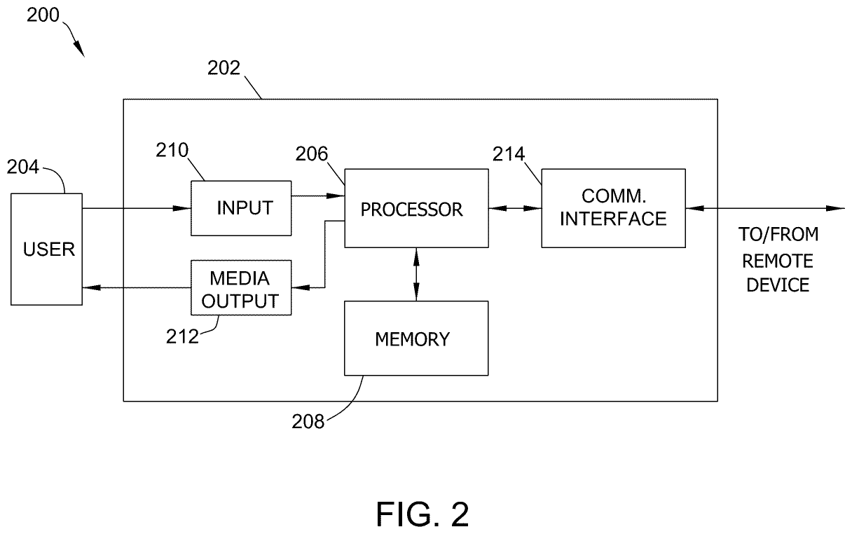

FIG. 2 illustrates a block diagram 200 of an exemplary client computing device 202 that may be used with the Learning Path (LP) computing system 100 shown in FIG. 1. Client computing device 202 may be, for example, at least one of devices 108a-108c, 112, and 110a-110c (all shown in FIG. 1).

Client computing device 202 includes a processor 206 for executing instructions. In some embodiments, executable instructions are stored in a memory 208. Processor 206 may include one or more processing units (e.g., in a multi-core configuration). Memory 208 may be any device allowing information such as executable instructions and/or other data to be stored and retrieved. Memory 208 may include, but is not limited to, one or more computer readable media.

In some exemplary embodiments, processor 206 may include and/or be communicatively coupled to one or more modules for implementing the systems and methods described herein. For example, in one exemplary embodiment, a module may be provided for receiving data and building a model based upon the received data. Received data may include, but is not limited to, one or more training datasets of historical data. A model is built by relating the received data, either by a different module or the same module that received the data. Processor 206 may include, or be communicatively coupled to, another module for designing a learning path based upon the received data.

In one or more exemplary embodiments, computing device 202 includes at least one media output component 212 for presenting information to a user 204. Media output component 212 may be any component capable of conveying information to user 204. In some embodiments, media output component 212 may include an output adapter such as a video adapter and/or an audio adapter. An output adapter may be operatively coupled to processor 206 and operatively coupled to an output device such as a display device (e.g., a liquid crystal display (LCD), a light emitting diode (LED) display, an organic light emitting diode (OLED) display, a cathode ray tube (CRT) display, an “electronic ink” display, a projected display, etc.) or an audio output device (e.g., a speaker arrangement or headphones). Media output component 212 may be configured to, for example, display a status of the model and/or display a prompt for user 204 to input user data. In another embodiment, media output component 214 may be configured to, for example, display results generated by the model in response to one or more data inputs.

Client computing device 202 includes an input device 210 for receiving input from a user 204. Input device 210 may include, but is not limited to, a keyboard, a pointing device, a mouse, a stylus, a touch sensitive panel (e.g., a touch pad or a touch screen), or an audio input device. A single component, such as a touch screen, may function as both an output device of media output component 212 and an input of input device 210.

Client computing device 202 also includes a communication interface 214, which is communicatively coupled to one or more remote devices, such as LP computing device 102, shown in FIG. 1. Communication interface 214 may include, but is not limited to, a wired or wireless network adapter, a wireless data transceiver for use with a mobile phone network (e.g., Global System for Mobile communications (GSM), 3G, 4G, or Bluetooth) or other mobile data networks (e.g., Worldwide Interoperability for Microwave Access (WIMAX)). The systems and methods disclosed herein are not limited to any certain type of short-range or long-range networks.

Memory area 208 is configured to store, for example, computer readable instructions for providing a user interface to user 204 via media output component 212 and, optionally, receiving and processing input from input device 210. A user interface may include, but is not limited to, a web browser, mobile application, or a client application. Web browsers enable users, such as user 204, to display and interact with media and other information embedded on a web page, website, or the like.

Memory area 208 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAN). The above memory types are provided as illustrative examples only, and are thus not meant to be limiting.

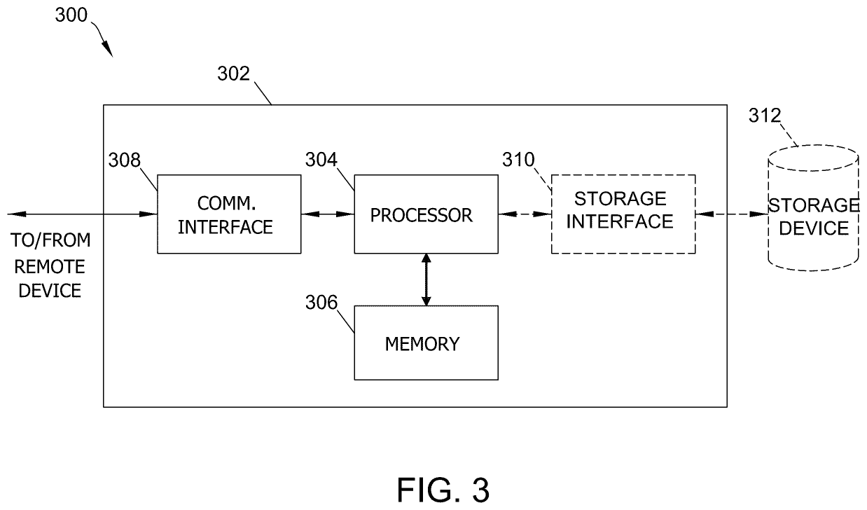

FIG. 3 depicts a block diagram 300 showing an exemplary server system 302 that may be used with a LP system (e.g., LP system 100 shown in FIG. 1). Server system 302 may be, for example, LP computing device 102 or database server 104 (shown in FIG. 1).

In exemplary embodiments, server system 302 includes a processor 304 for executing instructions. Instructions may be stored in a memory 306. Processor 304 may include one or more processing units (e.g., in a multi-core configuration) for executing instructions. The instructions may be executed within a variety of different operating systems on server system 302, such as UNIX, LINUX, Microsoft Windows®, etc. It should also be appreciated that upon initiation of a computer-based method, various instructions may be executed during initialization. Some operations may be required to perform one or more processes described herein, while other operations may be more general and/or specific to a particular programming language (e.g., C, C #, C++, Java, JavaScript, Python, or other suitable programming languages, etc.).

Processor 304 is operatively coupled to a communication interface 308 such that server system 302 is capable of communicating with LP computing device 102, user devices 108a-108c, client device 112, and LP systems 110a-110c (all shown in FIG. 1), and/or another server system. For example, communication interface 308 may receive data inputs from user devices 108a-108c, client device 112 and LP systems 110a-110c via a network connection, such as the Internet or a local area network.

Processor 304 is operatively coupled to a storage device 312, such as database 106 (shown in FIG. 1). Storage device 312 may be, for example, any computer-operated hardware suitable for storing and/or retrieving data. In some embodiments, storage device 312 may be integrated into server system 302. For example, server system 302 may include one or more hard disk drives as storage device 312. In other embodiments, storage device 312 may be external to server system 302 and accessed by a plurality of disparate server systems. For example, storage device 312 may include multiple storage units such as hard disks or solid-state disks in a redundant array of inexpensive disks (RAID) configuration. Storage device 312 may include a storage area network (SAN) and/or a network attached storage (NAS) system.

In some embodiments, processor 304 may be operatively coupled to storage device 312 via a storage interface 310. Storage interface 310 may be any component capable of providing processor 304 with access to storage device 312. Storage interface 310 may include, but is not limited to, an Advanced Technology Attachment (ATA) adapter, a Serial ATA (SATA) adapter, a Small Computer System Interface (SCSI) adapter, a RAID controller, a SAN adapter, a network adapter, and/or any component providing processor 304 with access to storage device 312.

Memory 306 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer system.

In a LP system (e.g., LP system 100 shown in FIG. 1), any area of knowledge (e.g., finance, algebra, etc.), learning style (e.g., visual, auditory, etc.), or skill area (e.g., creativity, deduction, etc.) can be broken into an interconnected, interdependent tree structure (a “tree diagram”) to map a user's progress within and across trees. In some embodiments, during a learning journey, the LP system sends a user through a combination of lessons and/or activities and the user is scored on a standardized scale based on their performance. The lessons and/or activities may consist of a combination of linear lessons and/or activities, check the user's progress with both linear and dynamic diagnostics that map the user's performance, and subsequently present micro-lessons based on individual user progress. The micro-lessons may be shorter lessons which focus in on a particular subtopic the user needs additional help with. In other embodiments, during a learning journey, the LP system sends a user through a plurality of micro-lessons.

The LP system may provide a plurality of different diagnostic types. In some embodiments, the LP system provides a linear, global and/or dynamic diagnostic types. The linear diagnostic type comprises manually defined questions and provides a standardized view of performance across users. The global diagnostic types comprises diagnostics which increases question difficulty based on user progress, which offers the user the ability to practice questions with increasing difficulty. The dynamic diagnostics type comprises working through a topic tree diagram to dynamically assess user performance. The dynamic diagnostics allows for “check-in” diagnostics to assess current user performance across a range of topics, skills, capabilities, and/or other dimensions and allows users to “test out” of particular topics.

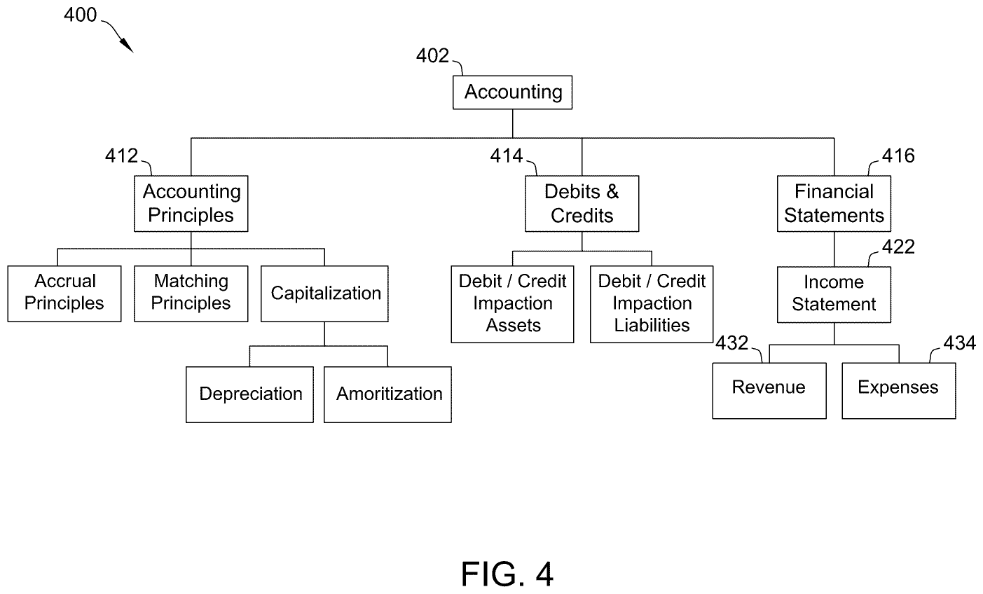

FIG. 4 is a first topic tree diagram 400 relating to an area of knowledge in accordance with an embodiment of the present disclosure. First topic tree diagram 400 comprises a root node 402, which corresponds to a relatively broad area of knowledge. For example, in the embodiment illustrated in FIG. 4, root node 402 corresponds to the broad topic area of accounting. However, root node 402 may correspond to a wide variety of topic areas, including but not limited to finance, mathematics, science, language, etc. the LP system breaks topic areas of study into a hierarchical taxonomy so a learner can navigate areas of study they need to master but doing it in an intuitive way. For example, first topic tree diagram 400 further comprises subtopics 412, 414, 416, which may increase in specificity the higher the subtopic is on the hierarchy. For example, in the embodiment illustrated in FIG. 4, broad topic 402 of accounting is broken into the following subtopics: Accounting Principles 412, Debits and Credits 414, and Financial Statements 416, which are broken down into further subtopics. For example, in the embodiment illustrated in FIG. 4, Financial Statements 416 comprises the subtopic of Income Statement 422, which is further broken down into the subtopics of Revenue 432 and Expenses 434. The LP system may create a topic tree diagram such as the one illustrated in FIG. 4 using machine learning techniques, as described in more detail below. During a learning journey, a user may complete one or more activities and/or exercises and answer a plurality of questions corresponding to the main topic and corresponding subtopics. As the user answers questions, the LP system is mapping a level of the user's performance relative to a goal that has been set. In the embodiment illustrated in FIG. 4, the LP system tracks the level of the user relative to a goal that has been set for that user for each subtopic. The user levels are standardized. For example, the levels may be a numerical scale of 1-5, with 1 corresponding to the easiest difficulty level and 5 corresponding to the hardest difficulty level. However, this numerical scale is by way of example only, and any standardized level system may be used.

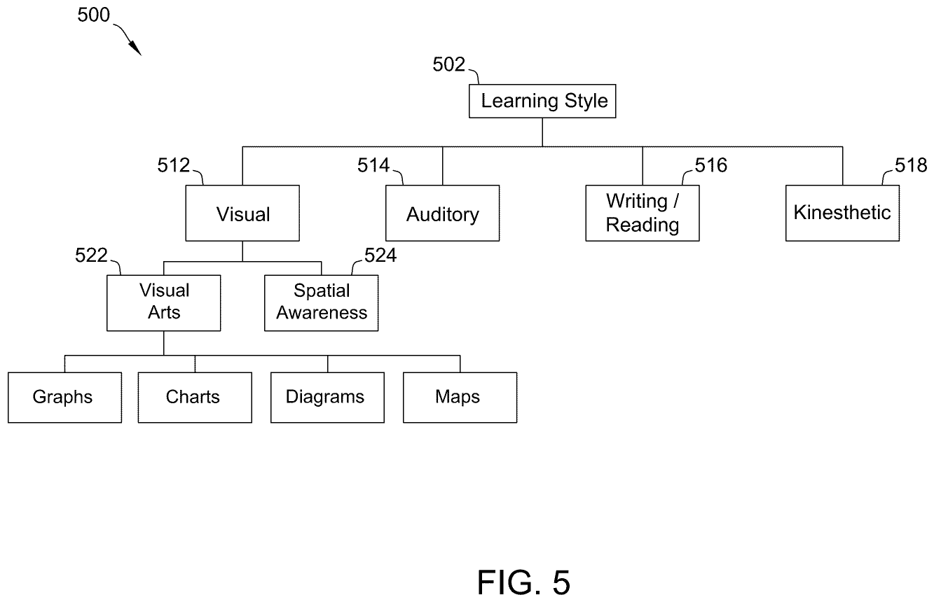

FIG. 5 is a second topic tree diagram 500 corresponding to learning styles in accordance with an embodiment of the present disclosure. Second topic tree diagram 500 comprises a root node 502 corresponding to Learning Style. The main topic of Learning Style 502 is broken into the subtopics of Visual 512, Auditory 514, Writing/Reading 516, and Kinesthetic 518. The subtopic Visual 512 is further broken down into Visual Aids 522 and Spatial Awareness 524, and so forth. During a learning journey, a user may answer a plurality of questions corresponding to the main topic and subtopics. As the user answers questions, the LP system (e.g., LP system 100 shown in FIG. 1) is mapping a level of the user's performance relative to a goal that has been set. In the embodiment illustrated in FIG. 5, the LP system tracks the level of the user relative to a goal that has been set for that user for each subtopic (e.g., Visual 512, Auditory 514, Writing/Reading 516, and Kinesthetic 518). The user levels are standardized. For example, the levels may be a numerical scale of 1-5, with 1 corresponding to the easiest difficulty level and 5 corresponding to the hardest difficulty level. However, this numerical scale is by way of example only, and any standardized level system may be used.

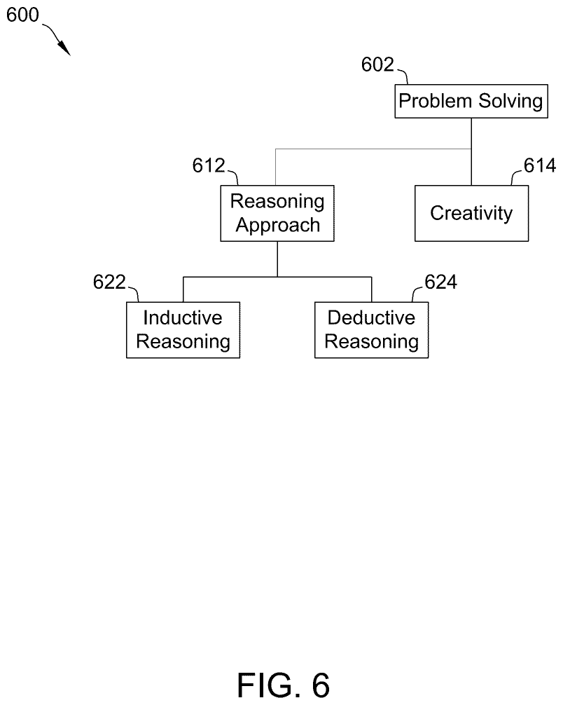

FIG. 6 is a third topic tree diagram 600 corresponding to problem solving skills in accordance with an embodiment of the present disclosure. Third topic tree diagram 600 comprises a root node 602 corresponding to Problem Solving Skills. Problem Solving Skills 602 is further broken into the subtopics of Reasoning Approach 612 and Creativity 614. The subReasoning approach 612 is further broken down into Inductive Reasoning 622 and Deductive Reasoning 624. During a learning journey, a user may answer a plurality of questions corresponding to the subtopics. As the user answers questions, the LP system (e.g., LP system 100 shown in FIG. 1) is mapping a level of the user's performance relative to a goal that has been set. In the embodiment illustrated in FIG. 6, the LP system tracks the level of the user relative to a goal that has been set for that user for each subtopic. The user levels are standardized. For example, the levels may be a numerical scale of 1-5, with 1 corresponding to the easiest questions and 5 corresponding to the hardest questions. However, this numerical scale is by way of example only, and any standardized level system may be used.

As discussed above, trees, such as the trees illustrated in FIGS. 4-6, may be interconnected and/or interdependent, and a user's progress within and across trees may be tracked, as discussed in more detail below.

A user's score may be updated as a user progresses through a learning journey. For example, in some embodiments, a cumulative score level may be calculated for a user. The cumulative score increases by a certain amount (e.g., the user's score level multiplied by a coefficient) when the user answers a question correctly and decreases a certain amount (e.g., the user's score level multiplied by a coefficient) when the user answers a question incorrectly. In some embodiments, the cumulative score is only increased if the question corresponds to a higher difficulty level than the user's current score level and decreased if the question corresponds to a lower difficulty level than the user's current score level. Stated another way, the cumulative score will not increase or decrease in response to an answer to a question corresponding to the user's current score level.

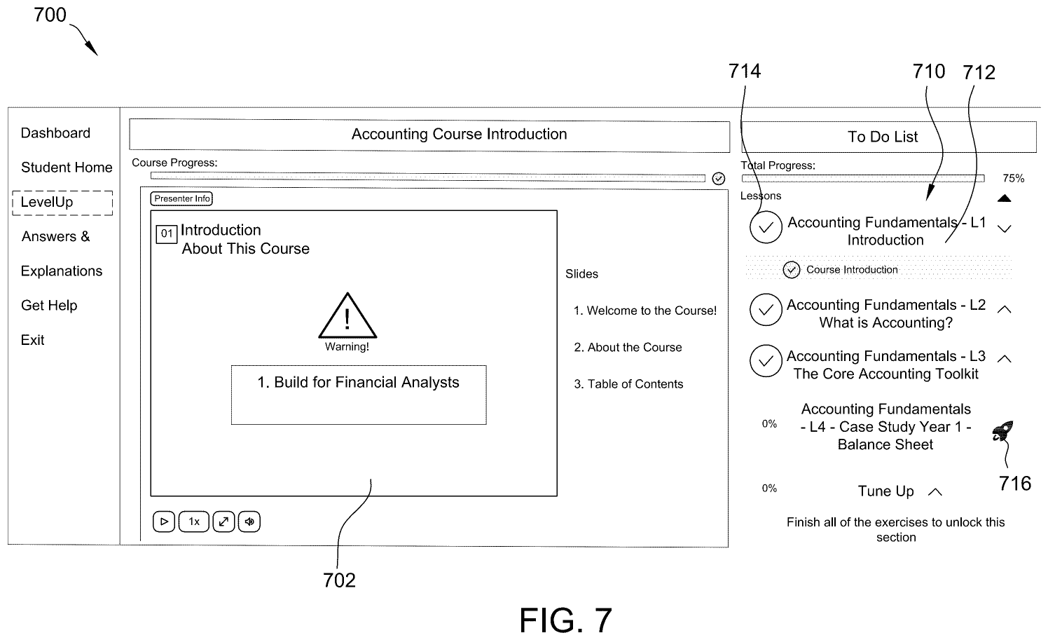

FIG. 7 is a knowledge course user interface 700 of an LP system (e.g., LP system 100 shown in FIG. 1) in accordance with an embodiment of the present disclosure. In some embodiments, knowledge course user interface 700 is provided to a user via a web browser or an application accessible via a mobile or other electronic device. Knowledge course user interface 700 may comprise a main display 702 for presenting information to and interacting with a user. Knowledge course user interface 700 may include a lesson path 710 comprising a plurality of lessons 712 associated with the knowledge course and a progress indicator 714 for each lesson 712. Each lesson may correspond to a linear lesson, a micro-lesson, a diagnostic activity, an exercise, or the like. In some embodiments, knowledge course user interface 700 further includes a recommended timeline for completing a course (not shown). The progress indicator may show a percentage of the lesson 712 the user has completed. In the embodiment illustrated in FIG. 7, once a user completes a lesson, the indicator may appear as a green check mark. As previously noted, a user may “test out” of a particular area in which they already have expertise, as noted below. In the embodiment illustrated in FIG. 7, user interface 700 comprises a test out indicator 716 for lessons in which the user already has expertise.

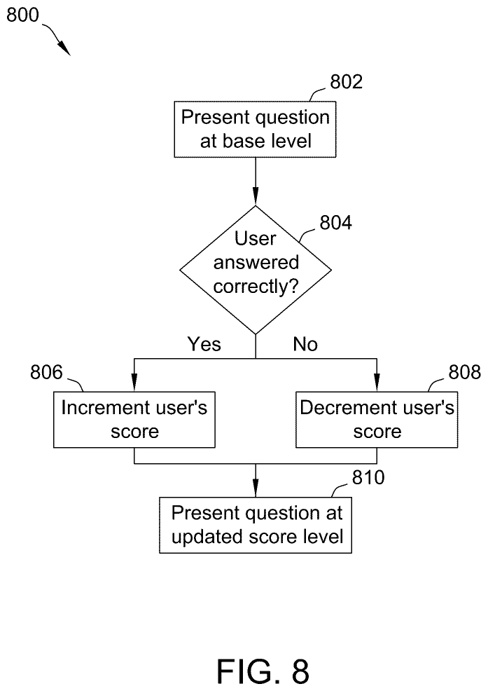

FIG. 8 is a flow diagram of global diagnostics 800 of a LP system (e.g., LP system 100 shown in FIG. 1) in accordance with an embodiment of the present disclosure. At 802, LP system presents a base level (e.g., “Level 1” or “easy”) question. This question may be presented on course user interface 700 (shown in FIG. 7). At 804, LP system determines whether the user answered the question correctly. If the user answered the question correctly, the LP system increases the user's score by a certain amount. For example, in the embodiment illustrated in FIG. 8, the user's score is incremented by a certain amount. For example, the LP system may increase a user's score by 1/(Number of Questions Per Level) at 806. For example, if there are four questions at the base level (e.g., “Level 1”), the user's score would be increased by one-fourth (0.25) of a point. If the user answered the question incorrectly, the LP system decrements the user's score by a certain amount. For example, the LP system may decrease the user's score by 1/(Number of Questions Per Level) at 808. Next, at 810, the LP system presents a question at the cumulative score level. In some embodiments, the cumulative score level is rounded down. So, if a user started at Level 1 and answered one of three questions correctly, the user's score will increase to 1.25 and the user will remain at Level 1. Once the user answers enough questions correctly to achieve 2 points, the user will then be presented a Level 2 question. After the user answers the question associated with the user's updated level, the process returns to 804. The 1-5 Scale Range is provided by way of example only, and any standardized range may be used to track a user's progress.

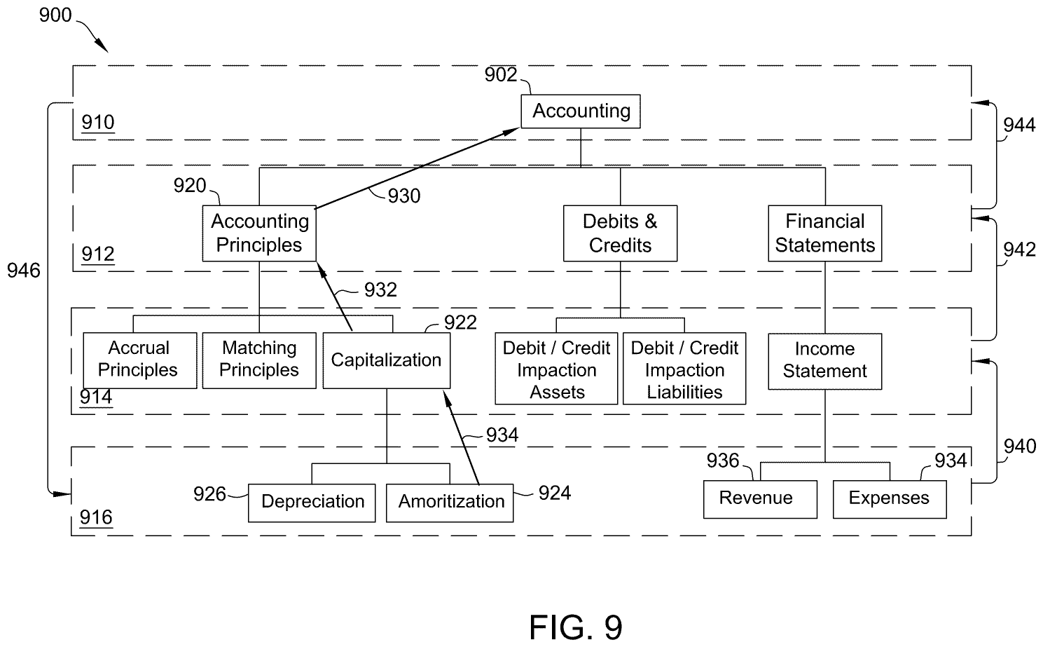

FIG. 9 is a tree diagram illustrating dynamic diagnostics 900 of a LP system (e.g., LP system 100 shown in FIG. 1) in accordance with an embodiment of the present disclosure. The dynamic diagnostics type comprises working through a topic tree diagram to dynamically assess user performance. The dynamic diagnostics allows for “check-in” diagnostics to assess current user performance and allows users to “test out” of particular topics. The embodiment illustrated in FIG. 9, tree diagram 900 for a learning journey corresponding to accounting, and comprises a root node 902 corresponding to the general topic of accounting and subtopics of accounting. Each subtopic belongs to a layer 910, 912, 914, 916 which corresponds to a hierarchical position of the respective subtopic within tree diagram 900. In the embodiment illustrated in FIG. 9, tree diagram 900 comprises four layers 910, 912, 914, 916. However, a dynamic diagnostics tree diagram that is part of the LP system may comprise any number of layers. The first and lowest layer 910 may correspond to the most general topic 902. As layers increase, subtopics increase in specificity. For example, in the embodiment illustrated in FIG. 9, subtopics of layer 912 are more specific than subtopics in layer 910, and subtopics in layer 914 are more specific than subtopics in layer 912, and so on. In some embodiments, the deeper (e.g., lower) layers are associated with increased difficultly. For example, in some embodiments, if the general topic area is mathematics, the lower layers may correspond to more advanced topics, such as calculus and linear algebra, and the higher layers may correspond to simpler topics, such as arithmetic and geometry. Additionally, or alternatively, the higher layers are more general topics, and the lower layers are more specific topics. In dynamic diagnostics, if at any point in time during the learning journey the user answers a certain number of questions incorrectly, the user must start from the beginning of the entire course or, in some embodiments, the beginning of the lesson. In dynamic diagnostics, the LP system begins a learning journey with the deepest layer associated with the most specific and/or complex topics. The LP system progresses randomly through the entire layer until all subtopics within the layer are covered. In the embodiment illustrated in FIG. 9, the LP system begins with layer 916, presenting questions associated with the most specific subtopics of Depreciation 926, Amortization 924, Revenue 936, and Expenses 934 in a random order. Once the user has answered for all subtopics within the lowest layer 916, LP system will progress to the next layer 914 (designated by arrow 940) and present questions associated with subtopics in layer 914, then progress to layer 912 (designated by 942), and so on, until the user has progressed to the top layer 910 (designated by 944). The LP 100 then returns to the deepest layer 916 (designated by arrow 946). As a user works through the layers of tree diagram 900, the LP system tracks the user's score for subtopics and/or skills. The LP system may compare such scores to goal scores for the user. The goal scores may align with where the user “wants to be”. The LP system may further calculate a cumulative score, which increases and decreases based on the user's performance.

If a user answers a certain number of questions for one or more topics and/or subtopics incorrectly on a prior loop, the LP system may present questions at a lower level on a subsequent loop. For example, if on the first round the user answered a predetermined number of Level 3 questions for a subtopic incorrectly, the LP system will present Level 2 questions to the user for that respective subtopic during the next, subsequent round.

Similarly, on a subsequent loop up the layers of tree diagram 900, for subtopics in which user answered a predetermined number of questions correctly, the LP system presents questions at a higher level than the previous questions on that subtopic. For example, if on the first round the user answered a predetermined number of Level 3 questions for a subtopic incorrectly, the LP system will present Level 4 questions to the user for that respective subtopic during the next, subsequent round. If the goal score/level has been reached (e.g., Level 5), then the respective subtopic may be skipped on the next round.

When calculating a cumulative score, a user's score for a lower subtopic, or child node, may feed into the user's score for a higher subtopic, or parent node. For example, in the embodiment illustrated in FIG. 9, a user's score for Amortization 924 may feed into the user's score for Capitalization 922 (designated by arrow 934), since Amortization 924 is a subcategory, or a child node, of Capitalization 922, the user's score for Capitalization 922 may feed into the user's score for Accounting Principles 920 (designated by arrow 932), and Accounting Principles 920 may feed into the user's score for Accounting 902 (designated by arrow 930). In some embodiments, the user's score for a child node may only feed up into the calculation of the user's score for a parent's node if the user has answered a predetermined number of questions for the child node. In some embodiments, a user's score for a subtopic with lower subtopics may be calculated using a data aggregation calculation (e.g., weighted averages). For example, in the embodiment illustrated in FIG. 9, a user's score for Capitalization 922 may be determined by calculating a weighted average of the user's Capitalization 922, Amortization 924, and Depreciation 926 scores.

In some embodiments, if no questions have been answered for a subtopic, a score may still be calculated for that particular subtopic using the user's scores for child nodes connected to the respective subtopic (e.g., by calculating a weighted average of the lower subtopics linked to the higher subtopic). For example, in the embodiment illustrated in FIG. 9, if no direct questions have been answered for Capitalization 922, a user's score for Capitalization 922 may be calculated using the user's score for Amortization 924 and Depreciation 926. For example, the user's score for Capitalization 922 by taking a weighted average of the user's scores for Amortization 924 and Depreciation 926. In some embodiments, the calculated score may be de-weighted based on the number of child nodes and/or the number of answers per child node.

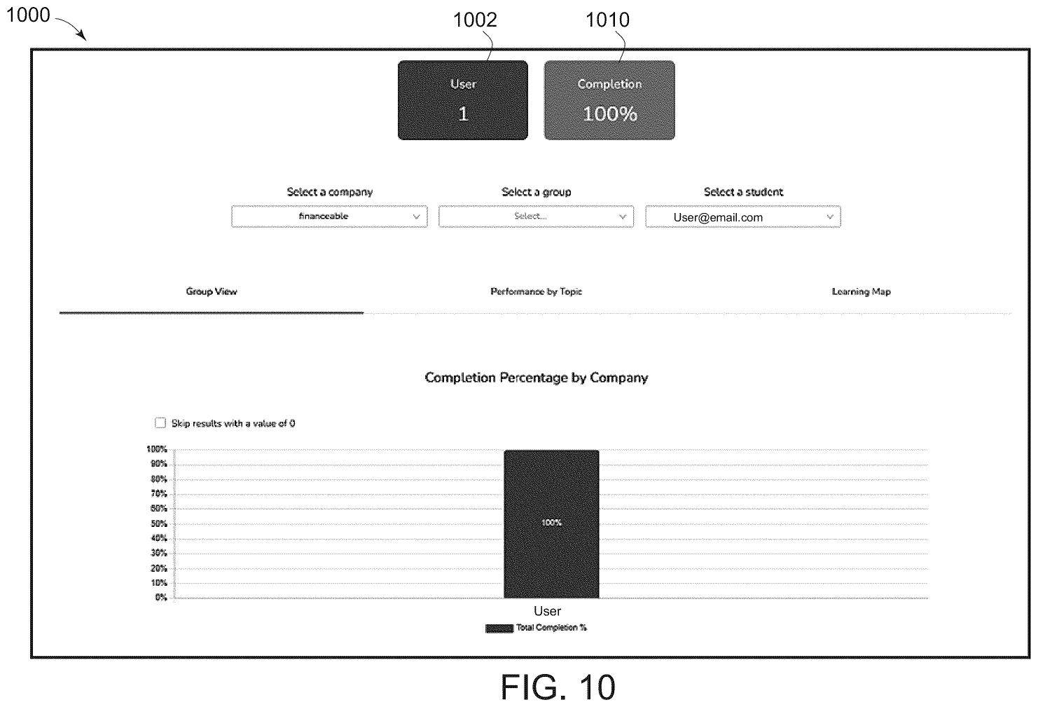

FIG. 10 is an example user statistics interface 1000 of a LP system (e.g., LP system 100 shown in FIG. 1) in accordance with an embodiment of the present disclosure. In some embodiments, performance for a user 10002 is aggregated into a single percentage completion metric 1010 based on progress within a particular leaning path or journey. The percentage completion metric may be calculated using the topic and subtopic score levels and the topic and subtopic goal levels.

The LP system may generate one or more prediction models to predict likely performance on particular topics within trees. For example, in some embodiments, the LP system may determine a likely score of a user for a particular topic and/or subtopic. For example, returning to FIG. 9, if no direct questions have been answered for Capitalization 922, the LP system calculates predictions for Capitalization 922 based on other completed learning activities by leveraging machine learning techniques. Additionally, or alternatively, the LP system may determine a likelihood that a user will answer a question within a certain topic and/or subtopic, at a certain level, correctly or incorrectly.

The one or more prediction models may comprise machine learning algorithms (e.g., Random Forest). In some embodiments, “feature selection” may be used to optimize for the most predictive individual questions and/or activities. In some embodiments, the LP system generates the one or more prediction models one or more training datasets of historical data. A model is built by relating the received data, either by a different module or the same module that received the data.

As more datapoints become available, the LP system may use a neural network structure (e.g., recurrent neural network (RNN), convolutional neural network (CNN), etc.) to predict outcomes. In some embodiments, “feature selection” may be used to optimize for the most predictive individual questions and/or activities. The LP system may use clustering algorithms to identify users and find optimal learning paths.

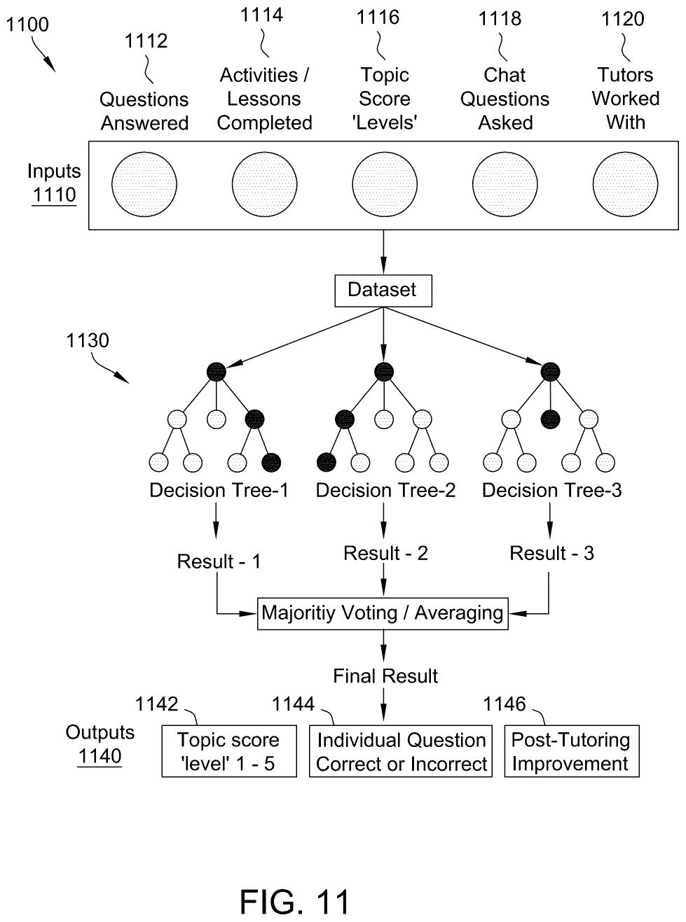

FIG. 11 is a schematic diagram illustrating a prediction model 1100 in accordance with an embodiment of the present disclosure. The LP machine learning programs may use one or more inputs 1110 to predict outcomes. The inputs may include one or more of questions answered 1112, activities and/or lessons completed 1114, topic score levels 1116, chat questions asked 1118, and/or tutors worked with 1120. Prediction model 110 may comprise one or more machine learning algorithms 1130 to generate one or more outputs 1140. In the embodiment illustrated in FIG. 11, a Random Forest algorithm is used, however, various other machine learning algorithms may be used (e.g., neural networks). Each of the outputs 1140 may correspond to a prediction. The predictions may correspond to a user's topic score level 1142, whether a user will answer a particular question correctly or incorrectly 1144, and/or whether or not tutoring will improve performance 1146, and if so, how much the user's performance will improve.

Additionally, or alternatively, LP machine learning programs may utilize clustering algorithms (e.g., k-mean clustering) to optimize a learning path. In machine learning, clustering involves the grouping of data points. When provided a set of data points, a clustering algorithm classifies each data point into a specific group. Data points that have similar properties and/or features may be grouped together, while data points in different groups have relatively dissimilar properties and/or features. Clustering algorithms may be used to cluster similar learners together and/or to determine optimal learning paths for different types of learners. Stated another way, the LP system (e.g., LP system 100 shown in FIG. 1) may determine that a user belongs to a particular cluster and can optimize a plurality of variables of the user's learning path based on the cluster which the user belongs to. For example, if the LP system determines that a user belongs to a particular cluster in which user's learn best via a video demonstration for particular topics, the LP system may create a learning path in which lessons for those particular topics are presented to the user via a video demonstration. The LP system may track a user's performance throughout the learning path and switch clusters when necessary. For example, a user grouped with a first cluster may be grouped with a second cluster if the user begins to answer questions more in alignment with the second cluster.

The LP system may further generate one or more LP models which leverage generative artificial intelligence (AI) (e.g., ChatGPT, etc.) to build topic structures and lesson plan structures. For example, in some embodiments, the LP model uses generative AI to determine topics and/or subtopics within a subject area. In further embodiments, the LP model uses generative AI to generate topics tree diagrams for the topics and/or subtopics of the subject area. In even further embodiments, LP model uses generative AI to generate questions and/or lesson content in a variety of formats (e.g., video, “explain it like I am 5 years old”, “3-minute video”, etc.) for the topics and/or subtopics. By using generative AI, LP system can create an infinite number of lessons and questions around an infinite number of topics with which a user can learn and practice, as discussed in more detail below.

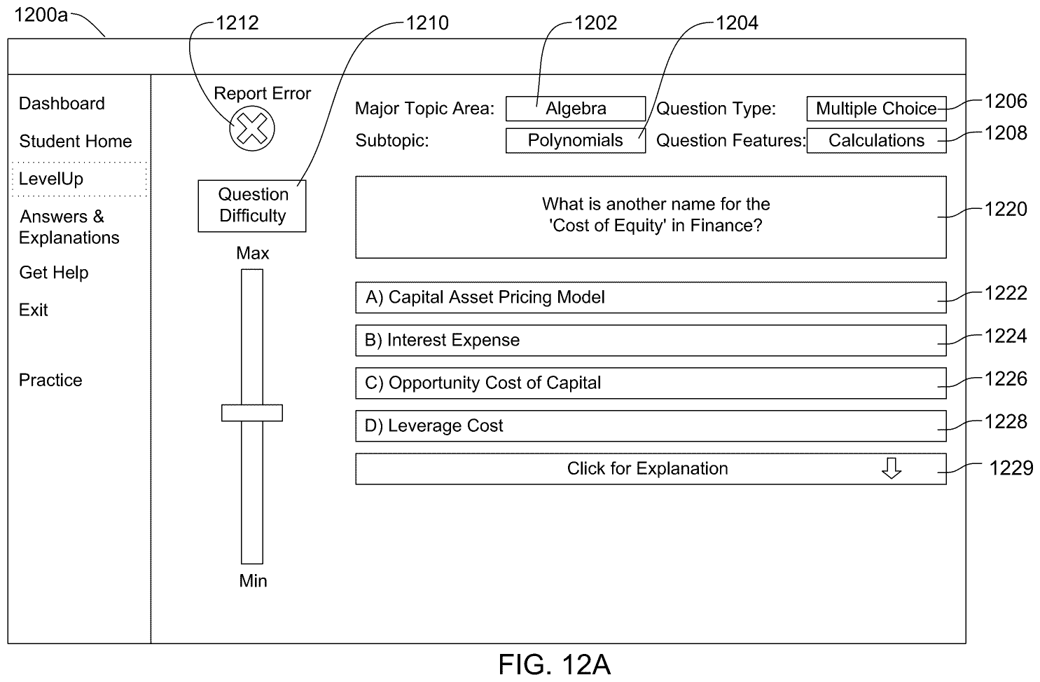

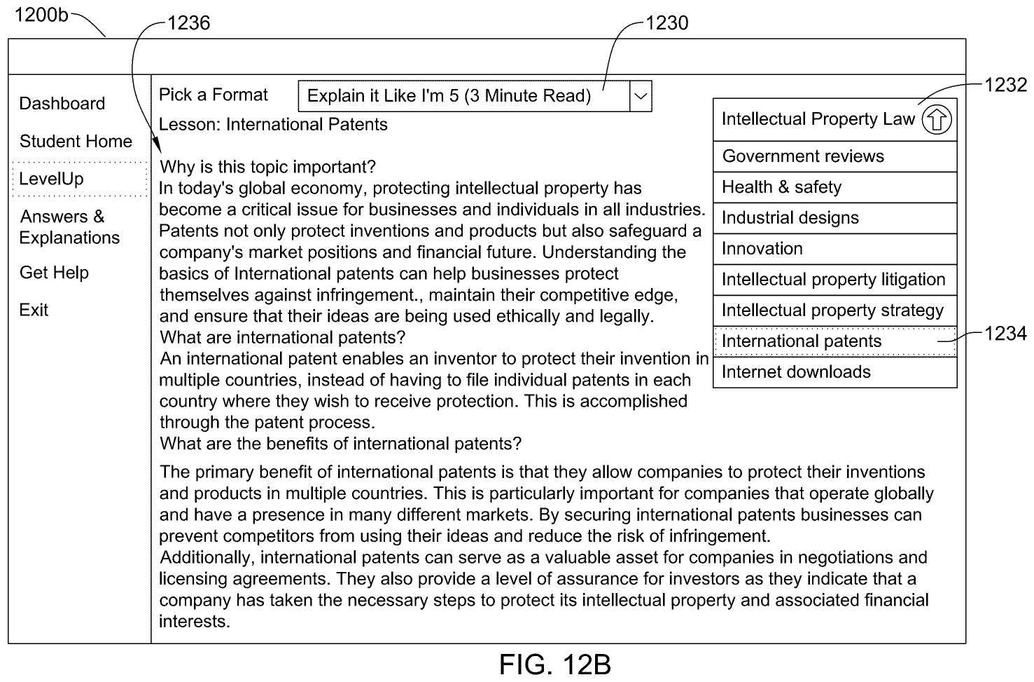

FIG. 12A is a question creation user interface 1200a of a LP system (e.g., LP system 100 shown in FIG. 1) in accordance with an embodiment of the present disclosure. Question creation user interface 1200a may comprise a plurality of fillable data fields and/or selection data fields, where a user may enter and/or select their LP path selections. In the embodiment illustrated in FIG. 12A, a user may enter a main topic 1202 (e.g., algebra) and/or a subtopic 1204 (e.g., polynomials), as well as a question type 1206 (e.g., multiple choice) and/or question features 1208 (e.g., calculations). A user may additionally select a question difficulty 1210. These possible selections are provided by way of example only, and more or fewer selections may be possible. For example, a user may further specify a number of answer choices to generate, a feature of the question, a minimum or maximum word count for the explanation, and the like. Further, the fillable fields of FIG. 12A are also by way of example only, and the user's selections may be made by various other mechanisms.

The LP model may use the user's selections to generate one or more questions 1220 and one or more answers 1222, 1224, 1226, 1228. In some embodiments, the LP model leverages generative AI to generate the questions. If a user changes one or more of their selections, the LP model may update accordingly. For example, the LP model generates a question based on a user's selections, and then a user increases the question difficulty on the toggle scale, the LP model updates the question to be more difficult. In some embodiments, the LP model generates one or more explanations 1224 for why an answer is correct or incorrect.

The LP model may further comprise a mechanism for reporting erroneous and/or not useful questions. In the embodiment illustrated in FIG. 12A, question creation user interface 1200a comprises a Report Error button 1212, which a user may use to report erroneous and/or not useful questions. This feedback may be fed back into LP model, and LP model may use this feedback to further refine the model.

FIG. 12B is a lesson user interface 1200b of a LP system (e.g., LP system 100 shown in FIG. 1) in accordance with an embodiment of the present disclosure. Question creation user interface 1200b may comprise a plurality of fillable data fields and/or selection data fields, where a user may enter and/or select their LP path selections. In the embodiment illustrated in FIG. 12B, a user may enter a main topic 1232 (e.g., intellectual property law) and/or a subtopic 1234 (e.g., international patents), as well as a format type 1230 (e.g., “explain it to me like I am 5years old”, “3-minute read”, etc.) In one embodiment, a user may additionally select a question difficulty. The fillable fields of FIG. 12B are also by way of example only, and the user's selections may be made by various other mechanisms.

The LP model may use the user's selections to generate one or more lessons 1236. In some embodiments, the LP model leverages generative AI to generate the lessons. If a user changes one or more of their selections, the LP model may update accordingly. For example, the LP model generates a lesson based on a user's selections, and then a user changes the format (e.g., “5-minute read”), the LP model updates the lesson to be a 5-minute read.

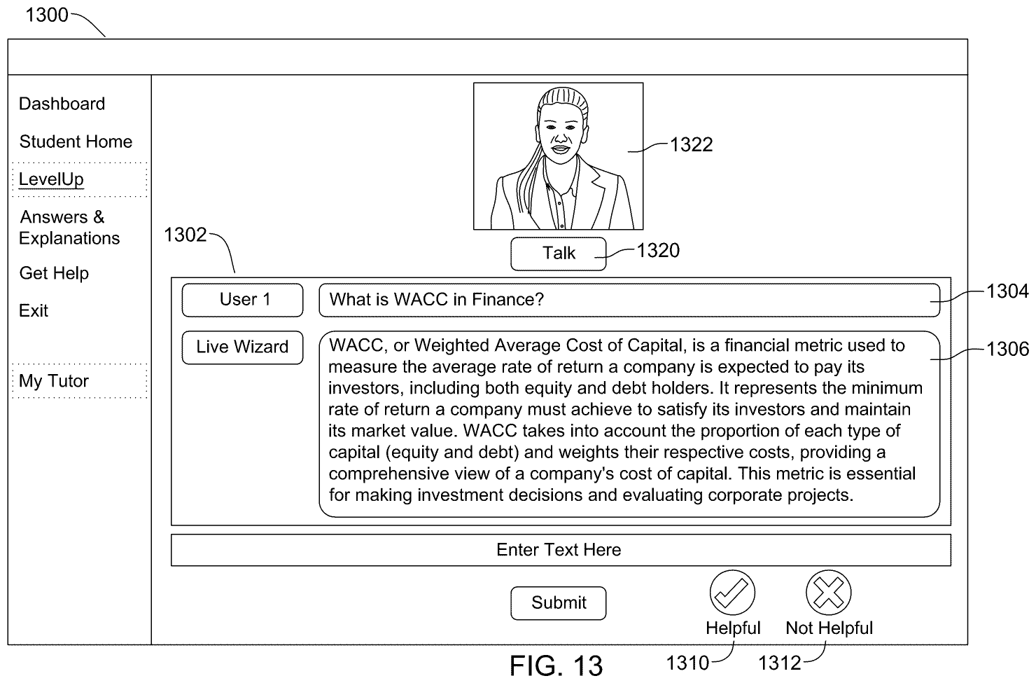

FIG. 13 is a tutor user interface 1300 of LP system in accordance with an embodiment of the present disclosure. The tutor user interface 1300 may comprise an automated tutor, such as a chatbot (e.g., ChatGPT bot), which a user may use to ask a question 1304 and receive an answer 1306 for said question. Additionally, or alternatively, tutor user interface 1300 comprises a talk button 1320 which a user may use to verbally ask their question using a microphone or other input device of the user's device (e.g., input device 210 of client computing device 202 illustrated in FIG. 2). The LP system (e.g., LP system 100 shown in FIG. 1) may utilize a speech to text function to convert the verbal question into text which is automatically entered into the chatbot 1302. The text of answer 1306 is then translated to verbal speech and auditorily presented via AI avatar 1322 to the user using speakers or other output device of the user's device (e.g., media output component 212 of client computing device 202 illustrated in FIG. 2).

In some embodiments, tutor user interface 1300 comprises a mechanism in which a user can provide feedback. In the embodiment illustrated in FIG. 13, tutor user interface 1300 comprises a helpful button 1310 which indicates that the automated tutor provided a helpful answer, and a not helpful button 1312 which indicates the automated tutor did not provide a helpful answer. The feedback from the user may be fed back into LP model, and LP model may use this feedback to further train and refine the model.

Other tutoring options may include live tutoring, meeting with certain people (e.g., other students, counselors, etc.). The LP system continuously seeks out best options available to the user to help them ultimately achieve goal completion.

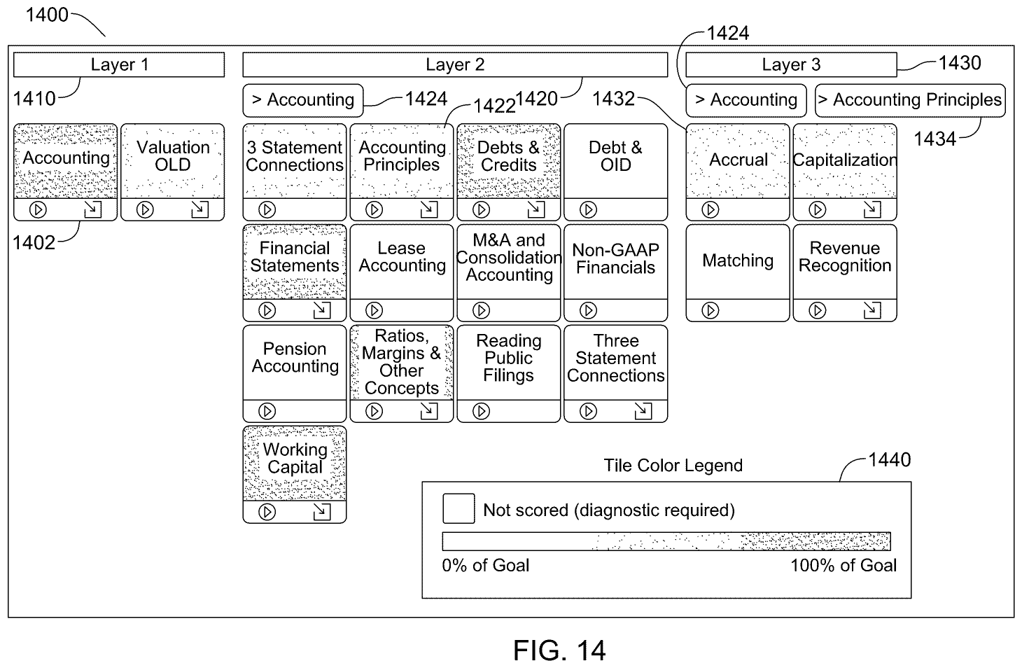

FIG. 14 is a basic multi-layer heat map user interface 1400 of LP system in accordance with an embodiment of the present disclosure. A heat map in accordance with the present disclosure may comprise a visual indication of a user's progress for topics 1402, subtopics 1422, and secondary subtopics 1432. For example, in the embodiment illustrated in FIG. 14, heat map 1400 color codes the topics, subtopics, and secondary subtopics of a learning path based on the user's percentage completion metric relative to the user's goals. For example, in some embodiments, green indicates the user has a higher percentage completion metric, and red indicates the user has a lower percentage completion metric. Heat map user interface 1400 may comprise a legend 1440. In the embodiment illustrated in FIG. 14, legend 1440 is a quantitative legend, representing a range of numerical values for the percentage completed metric. Additionally, or alternatively, legend may be a quantitative legend representing discrete categories. Heat map user interface 1400 may organize topics 1402, subtopics 1422, and secondary subtopics 1432 according to their layer on a tree diagram. For example, in the embodiment illustrated in FIG. 14, one of the main topics 1402 is Accounting, and is therefore displayed under heading “Layer 1” 1410. Further, subtopics 1422 (e.g., Accounting Principles), is displayed under heading “Layer 2” 1420 and secondary subtopics 1432 (e.g., Accrual) is under heading “Layer 3” 1430. In some embodiments, heat map user interface 1400 further comprises one or more navigational aids. For example, in some embodiments, one or more breadcrumbs may be used for deeper layers to track the higher layers associated with a particular layer and as a navigational aid on the heat map user interface 1400. More particularly, the breadcrumbs may provide links to previous layers. For example, in the embodiment illustrated in FIG. 14, “Layer 2” 1420 comprises a first breadcrumb 1424 indicating the subtopics 1422 under “Layer 2” correspond to a main topic 1402 (e.g., Accounting). First breadcrumb 1424 may also comprise a link which navigates back to the main topic 1402 (e.g., Accounting). Similarly, “Layer 3” may further comprise a second breadcrumb 1434 indicating the subtopics of “Layer 3” 1430 correspond to a subtopic 1422 (e.g., Accounting Principles) and a main topic 1402 (e.g., Accounting). Second breadcrumb 1434 may also comprise a link that navigates back to a subtopic (e.g., Accounting Principles).

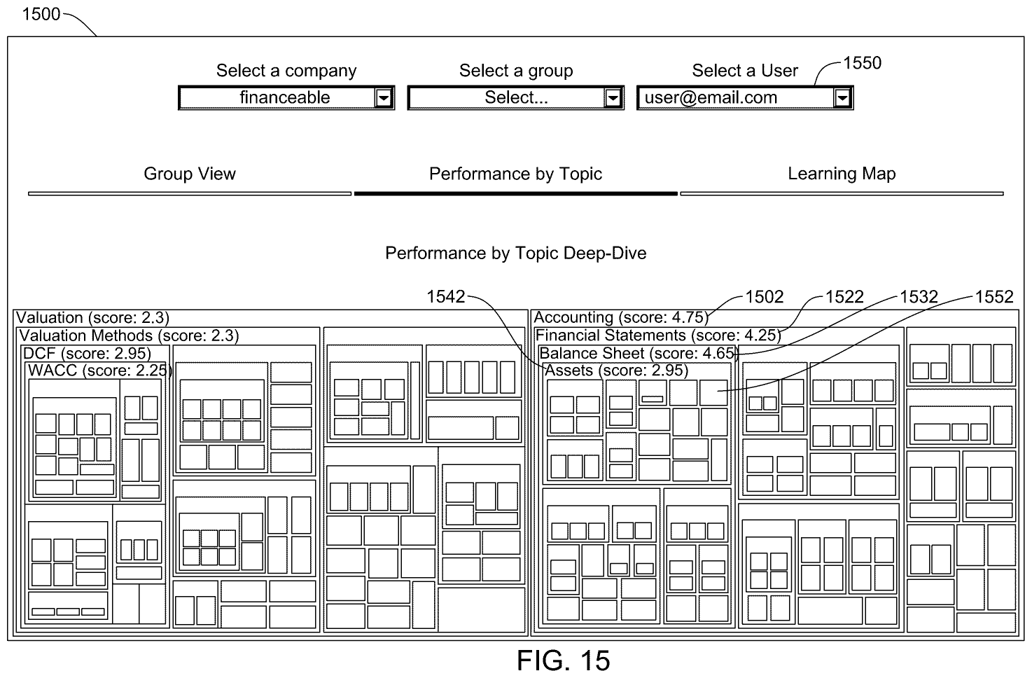

FIG. 15 is a comprehensive example heat map user interface 1500 of a LP system (e.g., LP system 100 shown in FIG. 1) in accordance with an embodiment of the present disclosure. Heat map user interface 1500 comprises a comprehensive, layered heating map for a particular user 1550. Comprehensive heat map user interface 1550 enables viewing of a user's progress with regards to multiple layers 1502, 1522, 1532, 1542 and subtopics 1552 of a tree diagram (e.g., tree diagram 900 illustrated in FIG. 9) at once so that the user's strengths and weaknesses within a topic may be easily deduced. In some embodiments, a user may zoom in and out of areas of the heat map (e.g., layers 1502, 1522, 1532, 1542).

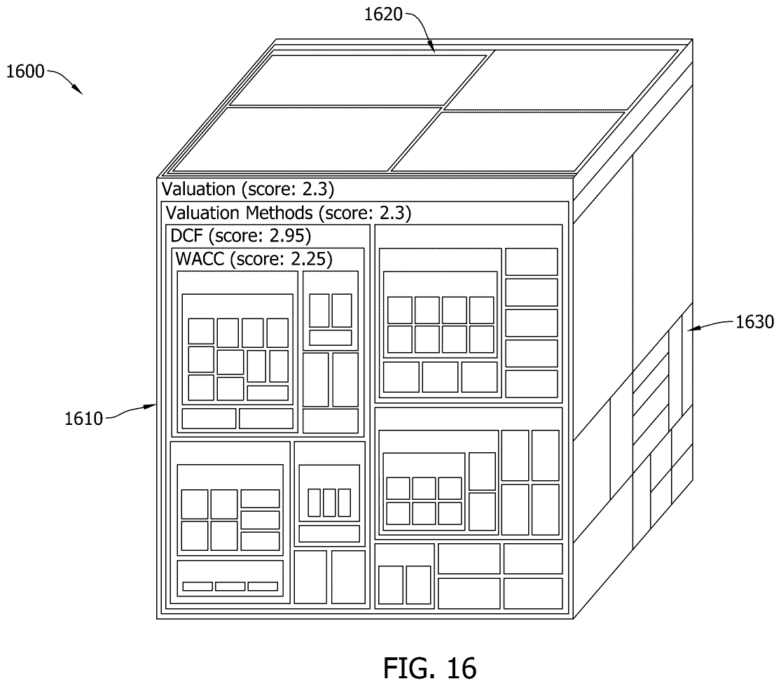

FIG. 16 is a multi-dimensional heat map user interface 1600 of LP system in accordance with an embodiment of the present disclosure. In the embodiment illustrated in FIG. 16, heat map user interface 1600 comprises a three-dimensional cube. Alternatively, multi-dimensional heat map user interface 1600 may comprise another multi-dimensional shape, such as a polyhedron. Each face of the multi-dimensional heat map user interface 1600 may cover different topic areas. For example, in the embodiment illustrated in FIG. 16, multi-dimensional heat map user interface 1600 first face 1610 corresponds to a user's progress regarding “Valuation” subject matter, second face 1620 corresponds to the user's progress regarding problem solving skills, and third face 1630 corresponds to the user's progress regarding learning style. The user's strengths and weaknesses within a topic, problem solving skills, learning styles, etc. may be easily deduced by viewing the multi-dimensional heat map user interface 1600.

The above-described heat maps may be shared with, for example, teachers, administrators, potential employers, and the like, to assist with determining the user's knowledge and strengths and provide a real-time view of a user's progress.

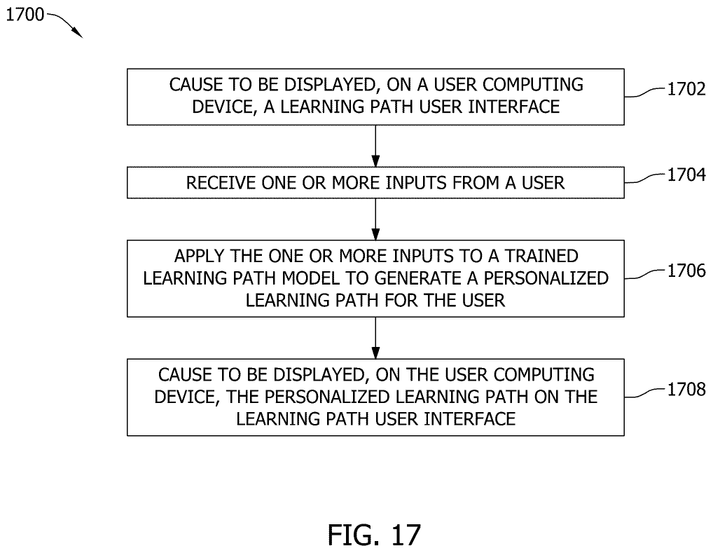

FIG. 17 is a method 1700 for generating and presenting a customized learning path in accordance with an embodiment of the disclosure. Method 1700 may be performed by a computing device comprising a processor and a memory, such as LP computing device 102 (shown in FIG. 1). At 1702, the processor causes to be displayed, on a user computing device (e.g., client computing device 202 illustrated in FIG. 2) a learning path user interface. At 1704, one or more inputs (e.g., topic area, question type, etc.) are received from a user. Next, the one or more inputs are applied to a trained learning path model to generate a personalized learning path for the user at 1706. The processor then causes to be displayed, on the user computing device, the personalized learning path on the learning path user interface at 1708. The personalized learning path may comprise a plurality of lessons.

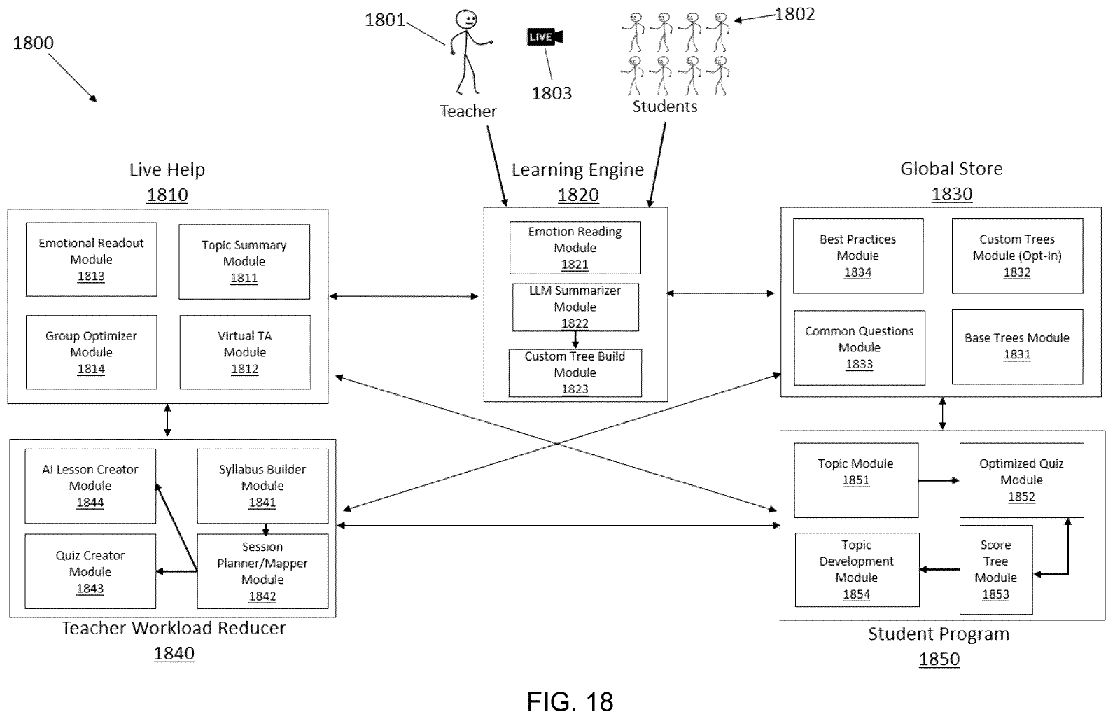

FIG. 18 is a schematic diagram of a learning management system 1800 in accordance with an embodiment of the present disclosure. Learning management system 1800 may be used by one or more teachers 1801 and one or more students 1802. Learning management system 1800 may comprise one or more processors comprising a live help component 1810, a learning engine 1820, a global store component 1830, a student program 1850, and a teacher workload reducer component 1840. Live help component 1810, learning engine 1820, global store component 1830, student program 1850, and teacher workload reducer component 1840 may be communicatively coupled to each other. More particularly, some or all of modules or elements 1810, 1820, 1830, 1840, and 1850 may be bi-directionally interconnected such that each such module is configured to send and receive messages from other modules. For example, live help component 1810 may be communicatively coupled to one or more of learning engine 1820, global store component 1830, teacher workload reducer component 1840, and/or student program 1850. Leaning engine 1820 may be communicatively coupled to one or more of live help component 1810, global store component 1830, teacher workload reducer component 1840, and/or student program 1850. Global store 1830 may be communicatively coupled to one or more of live help component 1810, learning engine 1820, teacher workload reducer component 1840, and/or student program 1850. Student program 1850 may be communicatively coupled to one or more of live help component 1810, learning engine 1820, global store 1830, and/or teacher workload reducer component 1840. Teacher workload reducer 1840 may be communicatively coupled to one or more of live help component 1810, learning engine 1820, global store component 1830, and/or student program 1850.

Global store 1830 may comprise a repository of structures for one or more courses and/or course topics, such as one or more topic trees for a course (e.g., topic tree diagram 400 shown in FIG. 4). For example, global store 1830 may comprise a base topic tree module 1831 comprising a plurality of base trees for one or more courses. In some embodiments, teacher workload reducer 1840 may include a syllabus builder module 1841 which receives one or more base trees for a particular course from base tree module 1831. Syllabus builder module 1841 may use the one or more base trees and an existing syllabus for the course to build a baseline syllabus for the course. More particularly, syllabus builder module 1841 may plug the language of the existing syllabuses for the course into the one or more base trees for the course. The baseline syllabus may then evolve as a course progresses, as described in more detail below.

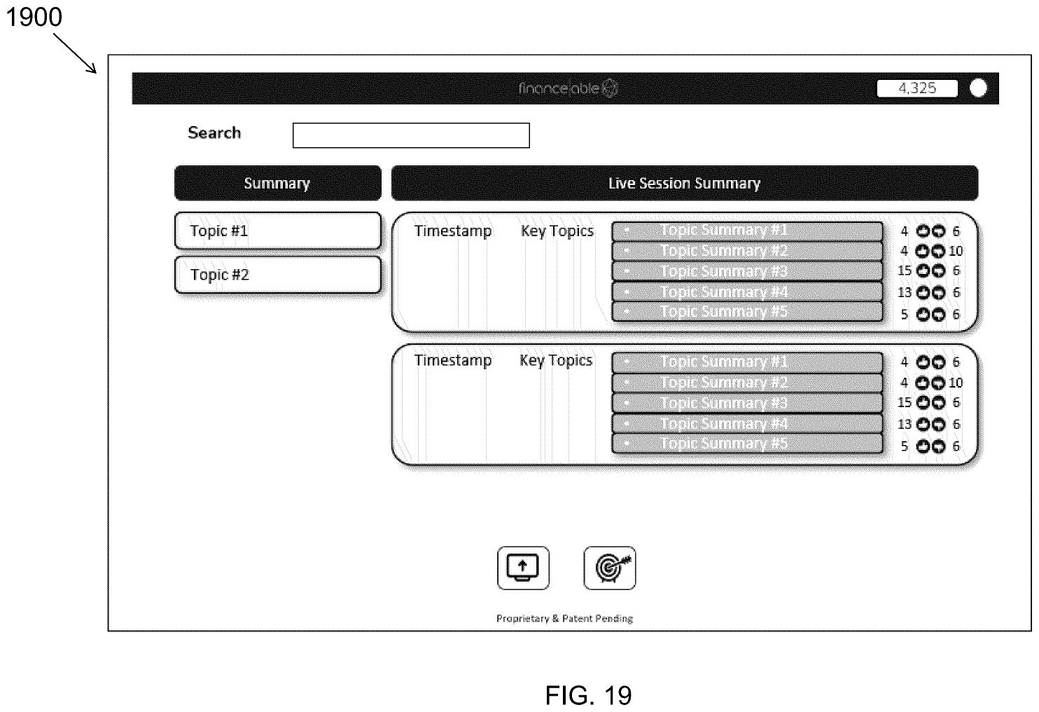

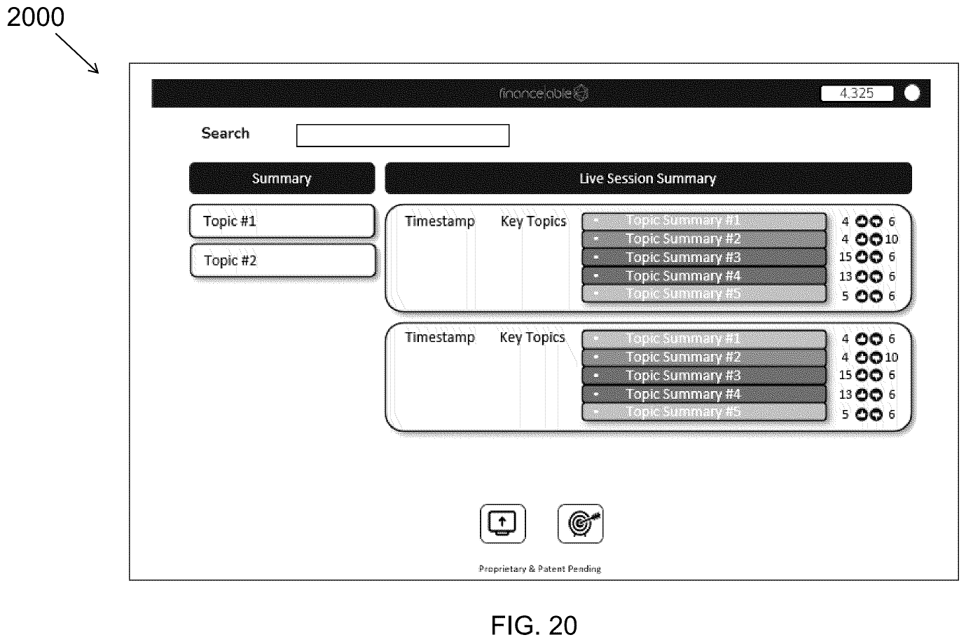

Students 1802 may each have a computing device (e.g., client computing device 200 shown in FIG. 2). Student computing device may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. Each student computing device may maintain a course application or course “app” which enables students to access information about the course. In some embodiments, students have access to a student version of the course app specifically designed for students. In some embodiments, the course app includes a topic summary interface which shows the plurality of topics covered in the class (e.g., topic summary interface 1900 shown in FIG. 19 or topic summary interface 2000 shown in FIG. 20), as described in more detail below. Students may interact with the course app via an input device on their computing devices (e.g., input device 210 shown in FIG. 2). In some embodiments, one or more summaries for each topic (e.g., a summary of the text converted from the teacher's speech generated by LLM summarizer 1822) may be transmitted to topic module 1851 of student program 1850 and accessible to students via topic summary interface, as described in more detail below.

In some embodiments, learning management system 1800 includes one or more microphones (not shown). For example, in some embodiments, a microphone is worn by teacher 1801. The speech of teacher 1801 during a lecture may be converted to text via large language model (LLM) summarizer module 1822 of learning engine 1820. LLM summarizer module 1822 may convert the speech to text using any method known in the art. In some embodiments, LLM summarizer module 1822 may summarize the text. For example, if teacher 1801 gives a lecture in on Topic 1, the LLM Summarizer module 1822 may translate the lecture from speech to text, and then generate a summary on the lecture of Topic 1. The summary comprise one or more paragraphs, one or more sentences, one or more bullet points, one or more keywords, and/or any other summary of the topic. The summary may be provided to students and/or teachers. For example, LLM summarizer module 1822 may transmit the summary to topic module 1851 of student program 1850 and may be accessible by students via a topic summary interface (e.g., topic summary interface 1900 shown in FIG. 19 or topic summary interface 2000 shown in FIG. 20).

In some embodiments, learning management system 1800 comprises one or more cameras 1803. In some embodiments, the one or more cameras 1803 consist of cameras located on or within one or more student computing devices (e.g., a webcam of student computing device). Learning engine 1820 may include an emotion reading module 1821. The image, video, and/or audio data from the one or more cameras 1803 may be transmitted to emotion reading module 1821. Emotion reading module 1821 may be configured to analyze the image, video, and/or audio data to determine student's responses to the material being taught. For example, in some embodiments, emotion reading module 1821 is configured to analyze the image, video, and/or audio data to determine student engagement, confusion, comprehension, and the like. The emotional readout data may be provided to teachers and/or students. For example, emotion reading module 1821 may transmit the emotional reading data to emotional readout module 1813, which provides an emotional readout of the emotional reading data, as described in more detail below. Additionally, or alternatively, emotion reading module 1821 may transmit emotional reading data to topic summary module 1811. Topic summary module 1811 may update one or more course topic summaries based on the emotional reading data. For example, if emotional reading data indicates a majority of students are confused by a particular course topic, the topic summary may include a textual or visual indication that students are confused, as discussed in more detail below with respect to topic summary interface 2000 shown in FIG. 20.

In some embodiments, students 1802 may provide feedback on the course via the course app. For example, a student may indicate that they understand a topic and are ready to move onto the next topic, or the student may indicate they do not understand a topic and therefore would like further instruction on the topic. In some embodiments, topic module 1851 updates topic summary interface (e.g., topic summary interface 1900 shown in FIG. 19 or topic summary interface 2000 shown in FIG. 20) based on student feedback and transmits the updated topic summary with student feedback to topic summary module 1811 of live help program 1810, as discussed in more detail below.

In some embodiments, optimized quiz module 1852 generates one or more questions for one or more students to assess the one or more students' comprehension of that topic (e.g., a quiz). LLM summarizer module 1822 may transmit topic data (e.g., a summary of a particular topic) to optimized quiz module 1852. Optimized quiz module 1852 may use the topic data to generate the one or more questions. In some embodiments, optimized quiz module 1852 may customize the one or more questions for one or more students. For example, optimized quiz module 1852 may customize the difficultly level of the one or more questions. In some embodiments, the course topics and/or topic trees and/or student feedback may be stored on topic module 1851 and transmitted to optimized quiz module 1852. Additionally, or alternatively, student score levels and/or score trees may be stored on score tree module 1853 and transmitted to optimized quiz module 1852. The one or more questions may be generated by optimized quiz module 1852 based on information from topic module 1851 and/or score tree module 1853. In some embodiments, a student's score tree (e.g., a tree corresponding to a topic tree comprising the student's score for two or more topics of the topic tree) score level (e.g., as determined by the method described in FIG. 8), may be used to generate the one or more questions. For example, a student's score tree (e.g., a tree corresponding to a topic tree comprising the student's score for two or more topics of the topic tree) and/or score level for one or more topics may be used to generate a quiz that is at their current comprehension level or at just above their current comprehension level. Additionally, or alternatively, a student's feedback on a topic may be used to generate the questions. Score tree module 1853 may store and update student score levels and/or score trees.

Student program 1850 may include a topic development module 1854 which determines one or more topics the student should work on based on the student's feedback and/or the student's score level(s) and/or score tree. For example, if a student indicates in their feedback they do not understand a topic and their score level(s) corresponding to that topic are relatively low, topic development module 1854 may determine the student should work on that particular topic and provide additional lessons, quizzes, assignments, and the like, for the student to complete. In another example, if a student indicates in their feedback they understand a topic and their score level(s) corresponding to that topic are relatively high, topic development module 1854 may determine that a student should work on a more difficult topic and provide additional lessons, quizzes, assignments, and the like, for the student to complete. In some embodiments, lessons, quizzes, and the like may be generated for the determined development topics using the systems and methods described above.

Teacher workload reducer component 1840 may include session planner/mapper module 1842. In some embodiments, topic development module 1854 transmits assignments, quizzes, AI chats, etc. completed by one or more students to session planner/mapper module 1842. Information regarding additional lessons, quizzes, assignments, etc. completed by one or more students, student scores on additional quizzes, and/or student feedback may be used by session planner/mapper module 1842 to generate an updated session plan for teacher. The updated session plan may be based on the syllabus for the course. For example, if a group of students are not comprehending a topic, updated session plan may be updated to review the topic.

Teacher workload reducer component 1840 may further include quiz creator module 1843. Session planner/mapper module 1842 may transmit an updated session plan to a quiz creator module 1843. Information regarding additional lessons completed by one or more students, student scores on additional quizzes, and/or student feedback, as well as the updated session plan, may be used by quiz creator module 1843 to automatically generate one or more questions, quizzes, and the like. In some embodiments, quiz creator module 1843 is configured to automatically grade the generated questions, quizzes, and the like. For example, quiz creator module 1843 may be configured to grade multiple choice questions, open-ended questions, essays, and the like. In some embodiments, quiz creator module 1843 is trained over time to generate questions and/or grade per a user's specifications. In some embodiments, quiz creator module 1843 comprises one or more artificial intelligence/machine learning (AI/ML) models which may be trained over time.

Teacher workload reducer component 1840 may further include an AI lesson creator module 1844. Session planner/mapper module 1842 may transmit an updated session plan to AI lesson creator module 1844. AI lesson creator module 1844 may be configured to generate lessons, teach lessons, and the like. In some embodiments, AI lesson creator module 1844 include one or more trained AI/ML learning models configured to create one or more lessons, which may be based on one or more session plans from session planner/mapper module 1842. The one or more trained AI/ML models may be trained on data from the teacher (e.g., speech and text data from a teacher's lectures) over time. In this way, AI lesson creator module 1844 may teach lessons in the same manner and style as the teacher. In some embodiments, AI lesson creator module 1844 may generate and maintain an avatar of the teacher to teach such lessons.

Teacher 1801 may also have a computing device (e.g., client computing device 200 shown in FIG. 2). Teacher computing device may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. Teacher computing device may maintain a course application or course “app” which enables teachers to access information about the course. In some embodiments, teachers have access to a teacher version of the course app. The course app may include a topic summary interface (e.g., topic summary interface 1900 shown in FIG. 19 or topic summary interface 2000 shown in FIG. 20), as described in more detail below. Teacher may interact with the course app via an input device (e.g., input device 210 shown in FIG. 2) on their computing devices. In some embodiments, teacher may view student feedback on a course topic. For example, teacher may be able to access the student feedback. In this way, the teacher may know when students understand a topic and the course may proceed to the next topic and when students do not understand a topic and therefore teacher needs to spend more time on such topic. Additionally, or alternatively, teacher may receive individual or aggregate scores of students for one or more quizzes on a topic. Additionally, or alternatively, teachers may receive emotional readout data from emotional reading module 1821 indicating student engagement, comprehension, etc.

Global store 1830 may include a custom topic trees module 1832. In some embodiments, custom topic trees module 1832 is an opt-in feature. In some embodiments, base tree module 1831 may transmit one or more base trees to custom tree build module 1823 of learning engine 1820. Custom tree build module 1823 may use teacher feedback data, student feedback data, emotional readout data, and/or student quiz scores across a course topic tree (e.g., topic tree diagram 400 illustrated in FIG. 4) to modify a syllabus. For example, if a teacher says they would like to cover Topic 3 tomorrow instead of Topic 2, LLM summarizer module 1822 transmits this update to custom tree build module 1823 which will update the topic tree. Custom tree build module 1823 then transmits the updated topic tree to syllabus builder module 1841 which automatically updates the syllabus according to the updated course tree. In another example, if student feedback data, emotional readout data, and/or student quiz data indicates students are not comprehending a topic, syllabus builder module 1841 automatically updates the syllabus to include additional assignments for that topic.

Live help program 1810 may include virtual teaching assistant (TA) module 1812. AI lesson creator module 1844 may transmit one or more lessons to virtual TA module 1812. Virtual TA module 1812 may include one or more trained AI/ML models configured to determine key points, keywords, answers to common points of confusion, topics, not covered, and the like. In some embodiments, virtual TA module 1812 may provide personalized information for students. For example, virtual TA module 1812 may be configured to provide recommendations on how to teach a student (e.g., student is a visual learner so provide visual examples), what to teach a particular student (e.g., student would benefit from reviewing basic concepts taught in lower course), and the like.

Live help program 1810 may comprise a group optimizer module 1814. AI lesson creator module 1844 may transmit one or more lessons to group optimizer module 1814. Group optimizer module 1814 may be configured to provide optimal grouping of students for the one or more lessons, as well reviews, discussions, and the like. For example, in some embodiments, group optimizer module 1814 may group students according to their skill level and the like. For example, group optimizer module 1814 may determine it is optimal to have students of different skill levels in a group, and therefore assign students of varying skill levels to a group.

Global store 1830 may include a best practices module 1834 and common questions module 1833. Data regarding common topics covered in a course (e.g., a topic tree for the course, such as topic tree diagram 400 illustrated in FIG. 4), average comprehension of a topic within a course, common points of confusion in a topic or course, and the like, may be collected over time. Best practices module 1834 may determine optimal course features, such as an optimal tree structure for a course, an optimal syllabus for a course, and the like. Best practices module 1834 may transmit this information to virtual TA module 1812. Common questions module 1833 may be configured to identify topics and areas of a course which typically cause confusion among students and provide tools and resources for teachers in teaching those topics and areas. Common questions module 1833 may transmit this information to virtual TA module 1812. The information from best practices module 1834 and common questions module 1833 may be used to optimize the functions of virtual TA module 1812. For example, if a student is not comprehending a topic, TA module 1812 may provide tools and resources from common questions module 1833 to the student.

FIG. 19 is a is a topic summary user interface 1900 in accordance with an embodiment of the present disclosure. Topic summary user interface 1900 may be accessible via the course app. Topic summary user interface 1900 may include a topic summary section which lists one or more topics of the course, one or more topics covered so far in the course, and/or one or more topics included in the topic tree for the course and/or one or more topic trees for the course. Topic summary user interface may further comprise a live session summary section. In some embodiments, each live session (e.g., teacher lecture) is recorded and/or transcribed (e.g., using speech to text), summarized (e.g., via LLM summarizer 1822 shown in FIG. 18), and/or timestamped. Therefore, topic summary user interface may include a time stamp, a list of topics covered in the live session, and a link to a summary of one or more of the covered topics. Topic summary user interface 1900 may further comprise mechanisms for students to provide feedback. For example, in the embodiment illustrated in FIG. 19, students may “upvote” or “downvote” a live session and/or each topic within the live session. In some embodiments, an “upvote” may indicate a student understands the topic and a “downvote” may indicate the student needs further instruction on or review of the topic. Further, in the embodiment illustrated in FIG. 19, the number of students who upvoted or a downvoted a live session and/or a topic within a live session may be displayed. The information contained within topic summary user interface may be searchable via a search bar.

In some embodiments, topic summary user interface 1900 includes a presenter button which directs a user to the presenter's screen. In some embodiments, topic summary user interface 1900 also includes a quiz button which directs user to a quiz, which may be customized for a user, based on, for example, their score tree, as discussed in more detail above.

FIG. 20 illustrates an embodiment of topic summary user interface 2000, which includes all of the features and functionality of topic summary user interface 1900 illustrated in FIG. 19, but which further includes one or more visual indications of student comprehension with respect to each topic. The visual indications of student comprehension may be based on student feedback (e.g., upvotes and downvotes), emotional readout data, and/or student quiz scores. The visual indications may include color coding. For example, a topic generally well-understood by most students is shaded green, a topic well-understood by some students is shaded orange, and a topic which is not-well understood by most students is shaded red.

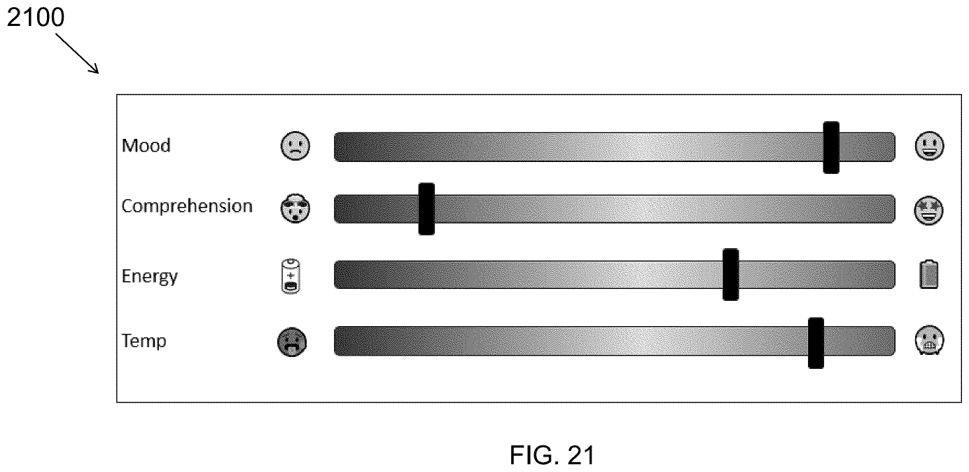

FIG. 21 is a diagram of emotional readout interface 2100, which may be accessible via course app, in accordance with an embodiment of the present disclosure. Emotional readout interface 2100 may be generated by emotional readout module 1813 (shown in FIG. 18). Emotional readout interface may include, but is not limited to student mood data, student comprehension data, student energy data, and/or temperature data. The emotional readout data may be presented via a sliding scale, as shown in the embodiment illustrated in FIG. 21. For example, mood data may be presented on a sliding scale of sad to happy, comprehension data may be presented on a scale of confused to completely comprehend, energy data may be presented on a scale of completely depleted to completely energized, and temperature data may be presented on a scale to really hot to really cold. The emotional readout data may also be presented using numerical indications (e.g., on a scale from 1 to 10), a graph, text, or any other data presentation. The emotional readout data may indicate to a teacher when students are confused, need a break, are engaged, and the like.

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a recurrent neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally, or alternatively, the machine learning programs may be trained by inputting sample data sets or certain data into the programs, such as course descriptions, job descriptions, historical learning paths, goals, and diagnostics, learning concepts, principles, or the like. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or machine learning.

In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing clement may be required to find its own structure in unlabeled example inputs.

Some embodiments involve the use of one or more electronic processing or computing devices. Some embodiments involve the use of one or more electronic processing or computing devices. As used herein, the terms “processor” and “computer” and related terms, e.g., “processing device,” “computing device,” and “controller” are not limited to just those integrated circuits referred to in the art as a computer, but broadly refers to a processor, a processing device, a controller, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processing (DSP) device, an application specific integrated circuit (ASIC), and other programmable circuits or processing devices capable of executing the functions described herein, and these terms are used interchangeably herein. The above are examples only, and thus are not intended to limit in any way the definition or meaning of the terms processor, processing device, and related terms.

In the embodiments described herein, memory may include, but is not limited to, a non-transitory computer-readable medium, such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROMs, DVDs, and any other digital source such as a network or the Internet, as well as yet to be developed digital means, with the sole exception being a transitory, propagating signal. Alternatively, a floppy disk, a compact disc-read only memory (CD-ROM), a magneto-optical disk (MOD), a digital versatile disc (DVD), or any other computer-based device implemented in any method or technology for short-term and long-term storage of information, such as, computer-readable instructions, data structures, program modules and sub-modules, or other data may also be used. Therefore, the methods described herein may be encoded as executable instructions, e.g., “software” and “firmware,” embodied in a non-transitory computer-readable medium. Further, as used herein, the terms “software” and “firmware” are interchangeable, and include any computer program stored in memory for execution by personal computers, workstations, clients and servers. Such instructions, when executed by a processor, cause the processor to perform at least a portion of the methods described herein.

Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the embodiments described herein, additional output channels may include, but not be limited to, an operator interface monitor.

The systems and methods described herein are not limited to the specific embodiments described herein, but rather, components of the systems and/or steps of the methods may be utilized independently and separately from other components and/or steps described herein.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

As used herein, an element or step recited in the singular and proceeded with the word “a” or “an” should be understood as not excluding plural elements or steps unless such exclusion is explicitly recited. Furthermore, references to “one embodiment” of the present disclosure or “an example embodiment” are not intended to be interpreted as excluding the existence of additional embodiments that also incorporate the recited features.

This written description uses examples to disclose various embodiments, which include the best mode, to enable any person skilled in the art to practice those embodiments, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A learning management (LM) system comprising at least one memory and at least one processor in communication with the at least one memory, wherein the at least one processor is programmed to:
receive, from a user, topic data corresponding to one or more lessons;
applying the topic data to one or more trained machine learning models to generate a topic summary corresponding to the one or more lessons;
cause to be displayed, on a user interface of a user computing device, the topic summary corresponding to the one or more lessons;
receive, via the user interface of the user computing device, feedback on the one or more lessons; and
update a course syllabus based on the feedback on the one or more lessons.

2. The LM system of claim 1, wherein the topic data comprises text data converted from speech detected by a microphone worn by the user.

3. The LM system of claim 1, wherein the feedback comprises upvotes and downvotes input by the user via the user interface of the user computing device.

4. The LM system of claim 1, wherein the at least one processor is further configured to generate a quiz corresponding to the one or more lessons.

5. The LM system of claim 4, wherein the at least one processor is further configured to:
receive, via the user interface of the user computer device, one or more answers to the quiz;
in response to receiving the one or more answers to the quiz, determine at least one score value for the quiz.

6. The LM system of claim 5, wherein the at least one processor is further configured to integrate the at least one score value into the feedback on the one or more lessons.

7. The LM system of claim 4, wherein the quiz is generated based on a difficulty level associated with the user.

8. A computer-implemented method for automatically generating learning materials, the method implemented using a computing system including a processor communicatively coupled to a memory device, the computer-implemented method comprising:
receiving, from a user, topic data corresponding to one or more lessons;
applying the topic data into one or more trained machine learning models to generate a topic summary corresponding to the one or more lessons;
causing to be displayed, on a user interface of a user computing device, the topic summary corresponding to the one or more lessons;
receiving, via the user interface of the user computing device, feedback on the one or more lessons; and
updating a course syllabus based on the feedback on the one or more lessons.

9. The computer-implemented method of claim 8, wherein the topic data comprises text data converted from speech detected by a microphone worn by the user.

10. The computer-implemented method of claim 8, wherein the feedback comprises upvotes and downvotes input by the user via the user interface of the user computing device.

11. The computer-implemented method of claim 8, further comprising generating a quiz corresponding to the one or more lessons.

12. The computer-implemented method of claim 11, further comprising:
receiving, via the user interface of the user computer device, one or more answers to the quiz;
in response to receiving the one or more answers to the quiz, determining at least one score value for the quiz.

13. The computer-implemented method of claim 12, further comprising integrating the at least one score value into the feedback on the one or more lessons.

14. The computer-implemented method of claim 11, wherein the quiz is generated based on a difficulty level associated with the user.

15. At least one non-transitory computer-readable medium comprising instructions stored thereon, the instructions executable by at least one processor to cause the at least one processor to perform steps including:
receive, from a user, topic data corresponding to one or more lessons;
input the topic data into one or more trained machine learning models to generate a topic summary corresponding to the one or more lessons;
cause to be displayed, on a user computing device, the topic summary corresponding to the one or more lessons via a topic summary user interface;
receive feedback on the one or more lessons via the topic summary user interface; and
update a course syllabus based on the feedback on the one or more lessons.

16. The at least one non-transitory computer-readable medium of claim 15, wherein the topic data comprises text data converted from speech detected by a microphone worn by the user.

17. The at least one non-transitory computer-readable medium of claim 15, wherein the feedback comprises upvotes and downvotes input by students via the topic summary user interface.

18. The at least one non-transitory computer-readable medium of claim 15, wherein the instructions further cause that at least one processor to generate a quiz corresponding to the one or more lessons.

19. The at least one non-transitory computer-readable medium of claim 18, wherein the instructions further cause that at least one processor to:
receive, via the user interface of the user computer device, one or more answers to the quiz;
in response to receiving the one or more answers to the quiz, determine at least one score value for the quiz.

20. The at least one non-transitory computer-readable medium of claim 19, wherein the at least one processor is further configured to integrate the at least one score value into the feedback on the one or more lessons.
